(19) United States
(12) Patent Application Publication
(10) Pub. No.: US 2025/0219329 A1
(43) Pub. Date: Jul. 3, 2025

(54) ELECTRICAL CONNECTOR AND CONNECTOR ASSEMBLY

(71) Applicant: LOTES CO., LTD, Keelung (TW)

(72) Inventors: Wen-Chang Chang, Keelung (TW); Wei-Xue Zhong, Keelung (TW); Biao Zhang, Keelung (TW); Zhi-Jun Feng, Keelung (TW); Zhuang-Fei Fu, Keelung (TW); Xiao-Ping Yi, Keelung (TW); Xian-Bin Li, Keelung (TW); Qing-Cheng Zeng, Keelung (TW)

(21) Appl. No.: 19/006,391

(22) Filed: Dec. 31, 2024

(30) Foreign Application Priority Data
Jan. 2, 2024 (CN) 202410011497.0
Jan. 2, 2024 (CN) 202410011613.9
Jan. 2, 2024 (CN) 202410012048.8
Jan. 2, 2024 (CN) 202410012851.1

(51) Int. Cl. H01R 13/6471; H01R 12/70; H01R 12/71

(52) U.S. Cl. CPC H01R 13/6471; H01R 12/716; H01R 12/707

(57) ABSTRACT

The present invention discloses an electrical connector and a connector assembly. The connector assembly includes an electrical connector, a mating component and a circuit board. The electrical connector includes a plurality of differential terminal pairs and at least one ground terminal. Each differential terminal pair includes two signal terminals. Each signal terminal includes a first contact portion, a first conductive portion and a first connecting arm. For the differential terminal pair, a central distance between the two first contact portions is greater than a central distance between the two first connecting arms, and the central distance between the two first contact portions is greater than a central distance between the two first conductive arms, such that the differential terminal pair forms a good differential coupling, and the distance between adjacent differential terminal pairs is increased, thereby reducing the far-end crosstalk between the differential terminal pairs.

### CROSS-REFERENCE TO RELATED PATENT APPLICATION

This non-provisional application claims priority to and the benefit of, pursuant to 35 U.S.C. § 119(a), patent application Serial Nos. CN202410012851.1, CN202410012048.8, CN202410011497.0 and CN202410011613.9, all filed in China on Jan. 2, 2024. The disclosure of each of the above applications is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector and a connector assembly, and particularly to an electrical connector and a connector assembly improving high frequency performances.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Peripheral Component Interconnect Express (PCI-Express or PCIe) is a high speed serial computer expansion bus standard, which has a previous name of “3GIO” and was proposed by Intel in 2001 with the intent to replace the older PCI, PCI-X and AGP bus standards.

With the increasing demand for faster data transmission technology, PCI Express has evolved from the 1.0 specification to the 6.0 specification. The PCI Express® 6.0 (PCIe® 6.0) specification was released by PCI-SIG® in January 2022. This latest generation of the PCIe standard brings many exciting new features aimed at enhancing performance for computation-intensive workloads, including data centers, AI/ML, and HPC applications. Since PCIe 3.0, data rates have doubled with each new generation, with PCIe 6.0 increasing the data rate to 64 gigatransfers per second (GT/s), which is twice the data rate of PCIe 5.0. Although PCIe 5.0 products are just hitting the market and PCIe 6.0 products have not yet been released, development for the PCIe 7.0 standard has already begun. Similarly, PCIe 7.0 aims to double the data rate of PCIe 6.0. The PCIe 7.0 connectors as well as corresponding electronic card and circuit board designs will undergo new changes to meet the requirements of the new generation of the PCIe protocol.

As the PCIe protocol advances, the required signal transmission rate continues to increase. However, the conventional PCIe connector assembly is unable to transmit the higher frequency signals to meet the requirements of the new generation of the PCIe protocol.

Therefore, a heretofore unaddressed need to design a new electrical connector exists in the art to address the aforementioned deficiencies and inadequacies.

### SUMMARY

The present invention is directed to an electrical connector and a connector assembly improving high frequency performances.

To achieve the foregoing objective, the present invention adopts the following technical solutions. An electrical connector includes: a main body; a plurality of differential terminal pairs provided in the main body; and at least one ground terminal provided in the main body, wherein the at least one ground terminal is provided between two adjacent ones of the differential terminal pairs along a longitudinal direction; wherein each of the differential terminal pairs comprises two signal terminals, each of the signal terminals comprises a first body portion, a first contact portion, a first conductive portion and a first connecting arm connected to one end of the first body portion and the first contact portion, the first body portion is located between the first connecting arm and the first conductive portion, the ground terminal comprises a second body portion, a second contact portion, a second conductive portion and a second connecting arm connected to one end of the second body portion and the second contact portion, and the second body portion is located between the second connecting arm and the second conductive portion; wherein for one of the differential terminal pairs, in the longitudinal direction, a central distance between the two first contact portions of the two signal terminals is greater than a central distance between the two first connecting arms of the two signal terminals, and the central distance between the two first contact portions of the two signal terminals is greater than a central distance between the two first conductive arms of the two signal terminals.

In certain embodiments, for the one of the differential terminal pairs, a side of each of the two first contact portions of the two signal terminals away from each other in the longitudinal direction comprises a first contact side edge, a side of each of the two first connecting arms of the two signal terminals away from each other in the longitudinal direction comprises a first connecting side edge, another side of each of the two first connecting arms of the two signal terminals adjacent to each other in the longitudinal direction comprises a second connecting side edge, the first contact side edge and the first connecting side edge of one of the two signal terminals are located on a same plane perpendicular to the longitudinal direction, the first body portion comprises a first retracted portion retracted relative to the first connecting side edge and a second retracted portion retracted relative to the second connecting side edge in the longitudinal direction, and a retraction distance of the first retracted portion is greater than a retraction distance of the second retracted portion.

In certain embodiments, the electrical connector includes a plurality of ground terminals, wherein two opposite sides of each of the differential terminal pairs are respectively provided with two ground terminals of the ground terminals, each of the differential terminal pairs and the two ground terminals at the two sides thereof are defined as a terminal group, for the two ground terminals in the terminal group, in the longitudinal direction, a central distance between the two second contact portions of the two ground terminals is greater than a central distance between the two second connecting arms of the two ground terminals, and the central distance between the two second contact portions of the two ground terminals is greater than a central distance between the two second conductive arms of the two ground terminals.

In certain embodiments, for the terminal group, in the longitudinal direction, the central distance between the two first connecting arms of the two signal terminals is greater than the central distance between the two first conductive arms of the two signal terminals, and the central distance between the two second connecting arms of the two ground terminals is greater than the central distance between the two second conductive arms of the two ground terminals.

In certain embodiments, for the terminal group, a side of each of the two second contact portions of the two ground terminals away from the differential terminal pair in the longitudinal direction comprises a first contact edge, a side of each of the two second connecting portions of the two ground terminals away from the differential terminal pair in the longitudinal direction comprises a first connecting edge, a side of each of the two second body portions of the two ground terminals away from the differential terminal pair in the longitudinal direction comprises has a first body edge, the first contact edge, the first connecting edge and the first body edge are located on a same plane, a side of each of the two second connecting arms of the two ground terminals adjacent to the differential terminal pair in the longitudinal direction comprises a second connecting edge, and the second body portion of each of the two ground terminals is provided with a retracted notch recessed inward relative to the second connecting edge such that the second body portion is away from the differential terminal pair.

In certain embodiments, the terminal group is fixed in an insulating block, the insulating block is provided with an inner slot corresponding to the second body portion, the inner slot runs through a surface away from the second body portion in a lateral direction, and the retracted notch is at least partially exposed in the inner slot.

In certain embodiments, the electrical connector includes a conductive plastic, wherein a portion of the second body portion located at a side of the retracted notch in the longitudinal direction is defined as a narrow portion, the conductive plastic is provided with a plurality of extending portions, the extending portions are one-to-one correspondingly in contact or adjacent to and electrically connected to the narrow portions of the ground terminals, and in the terminal group, a central distance between the two narrow portions of the two second body portions of the two ground terminals is greater than the central distance between two corresponding ones of the extending portions.

In certain embodiments, the electrical connector includes a plurality of ground terminals, wherein two ground terminals of the ground terminals adjacent to each other are provided between two adjacent ones of the differential terminal pairs, in the longitudinal direction, a distance between the two second conductive portions of the two ground terminals adjacent to each other is greater than a distance between the two second contact portions of the two ground terminals, and a central distance between the two second conductive portions of the two ground terminals is greater than a central distance between the two second contact portion of the two ground terminals.

Compared to the prior art, the present invention has the following beneficial effects:

In the differential terminal pair, a central distance between the two first contact portions of the two signal terminals is greater than a central distance between the two first connecting arms of the two signal terminals, and the central distance between the two first contact portions of the two signal terminals is greater than a central distance between the two first conductive arms of the two signal terminals, such that the differential terminal pair forms a good differential coupling, and the distance between adjacent differential terminal pairs is increased, thereby reducing the far-end crosstalk between the differential terminal pairs.

To achieve the foregoing objective, the present invention adopts the following technical solutions. An electrical connector includes: a main body, provided with a mating surface and an insertion slot, wherein the insertion slot is concavely formed in an insertion direction from the mating surface, two side walls are respectively provided at two opposite sides of the insertion slot along a lateral direction, the side walls are provided with a plurality of columns along a longitudinal direction, a signal slot is formed between two adjacent ones of the columns of a same one of the side walls, and any two of the longitudinal direction, the lateral direction and the insertion direction are perpendicular to each other; a plurality of terminal groups, provided in the main body, wherein each of the terminal groups comprises a differential terminal pair and two ground terminals located at two opposite sides of the differential terminal pair, the differential terminal pair comprises two signal terminals, each of the signal terminals comprises a first body portion, a first contact portion, a first conductive portion and a first connecting arm connected to one end of the first body portion and the first contact portion, the first body portion is located between the first connecting arm and the first conductive portion, each of the ground terminals comprises a second body portion, a second contact portion, a second conductive portion and a second connecting arm connected to one end of the second body portion and the second contact portion, the second body portion is located between the second connecting arm and the second conductive portion, the first contact portion and the second contact portion are exposed in the insertion slot, and the differential terminal pair is accommodated in the signal slot; and an insulating member, having a plurality of insulating protrusions, the insulating protrusions are located between the insertion slot and the two first connecting arms of the two signal terminals of the corresponding differential terminal pair in the lateral direction.

In certain embodiments, at least one of the side walls comprises a plurality of separation ribs, each of the separation ribs is located between the two first connecting arms of the two signal terminals of the differential terminal pair, a width of each of the separation ribs in the longitudinal direction is less than a width of each of the columns in the longitudinal direction, each of the separation ribs comprises a first far end away from the mating surface in the insertion direction, each of the columns comprises a second far end away from the mating surface in the insertion direction, and the first far end is provided to be closer to the mating surface than the second far end.

In certain embodiments, each of the separation ribs comprises a first side surface and a second side surface provided opposite to each other in the longitudinal direction, and the first side surface and the second side surface extend obliquely toward a side adjacent to the insertion slot in the lateral direction.

In certain embodiments, each of the signal terminals comprises a first tail portion connected to the first contact portion, the first tail portion and the first connecting arm are connected to two ends of the first contact portion in the insertion direction, at least one of the side walls comprises a plurality of protruding ribs, each of the protruding ribs is located between the two first tail portions of the two signal terminals of the differential terminal pair, each of the protruding ribs is provided to be closer to the mating surface than a corresponding one of the separation ribs, each of the protruding ribs and the corresponding one of the separation ribs are provided at an interval in the insertion direction, and the width of each of the separation ribs in the longitudinal direction and the width of each of the columns in the longitudinal direction are both less than a width of each of the protruding ribs in the longitudinal direction.

In certain embodiments, each of the signal terminals comprises a first tail portion connected to the first contact portion, at least one of the side walls comprises a plurality of protruding ribs and a plurality of grooves, each of the protruding ribs is located between the two first tail portions of the two signal terminals of the differential terminal pair, each of the grooves is located at a position corresponding to the differential terminal pair, each of the grooves is provided to correspond to a corresponding one of the protruding ribs between the differential terminal pair in the lateral direction, and each of the grooves runs through the mating surface in the insertion direction.

Compared to the prior art, the present invention has the following beneficial effects:

The insulating member has a plurality of insulating protrusions, and the insulating protrusions are accommodated in the signal slot and are located between the insertion slot and the differential terminal pair in the lateral direction. The insulating protrusions shield at least a portion of the two first connecting arms of the two signal terminals of the corresponding differential terminal pair in the lateral direction, thus reducing the air around the two first connecting arms of the differential terminal pair, increasing the dielectric constant around the two first connecting arms of the differential terminal pair, thus increasing the capacitance of the two first connecting arms of the differential terminal pair, reducing the characteristic impedance and making the impedance of the differential terminal pair more matched, and thereby improving high frequency performances.

To achieve the foregoing objective, the present invention adopts the following technical solutions. A connector assembly includes: an electrical connector, comprising a main body, wherein the main body is provided with a mating surface and an insertion slot, the insertion slot is concavely formed in an insertion direction from the mating surface, two side walls are respectively provided at two opposite sides of the insertion slot along a lateral direction, each of the side walls is provided with a plurality of differential terminal pairs and a plurality of ground terminals arranged along a longitudinal direction, and any two of the longitudinal direction, the lateral direction and the insertion direction are perpendicular to each other, wherein each of the differential terminal pairs and two of the ground terminals at two sides thereof form a terminal group, each of the differential terminal pairs comprises two signal terminals, each of the signal terminals comprises a first body portion, a first contact portion, a first connecting arm connected to one end of the first body portion and the first contact portion and a first conductive portion extending from the other end of the first body portion, each of the ground terminals comprises a second body portion, a second contact portion, a second connecting arm connected to one end of the second body portion and the second contact portion and a second conductive portion extending from the other end of the second body portion, and the first contact portion and the second contact portion are exposed in the insertion slot; a mating component, comprising a mating region inserted in the insertion slot, wherein the mating region comprises a first surface and a second surface provided to be opposite to each other in the lateral direction, the first surface and the second surface are both provided with contact fingers arranged at equal intervals along the longitudinal direction, the contact fingers comprise a plurality of signal contact fingers and a plurality of grounding contact fingers, the first contact portion is in contact with a corresponding one of the signal contact fingers, and the second contact portion is in contact with a corresponding one of the grounding contact fingers; and a circuit board, wherein the electrical connector is mounted on the circuit board, the circuit board is provided with a plurality of conductive pads arranged in rows, the conductive pads in each row comprise a plurality of conductive pad groups, each of the conductive pad groups comprises a pair of signal conductive pads and two grounding conductive pads, the first conductive portion is soldered to a corresponding one of the signal conductive pads, the second conductive portion is soldered to a corresponding one of the grounding conductive pads, and in the longitudinal direction, a central distance between two of the signal contact fingers in contact with a same one of the differential terminal pairs is greater than a central distance between two of the signal conductive pads in contact with the same one of the differential terminal pairs.

In certain embodiments, the mating region comprises a mating edge and at least one grounding layer located between the first surface and the second surface, the mating edge and the signal contact fingers are provided at intervals in the insertion direction, one side of each of the grounding contact fingers close to the mating edge along the insertion direction is connected to an extending finger, each of the extending finger is disposed on one of the first surface and the second surface, a width of the extending finger in the longitudinal direction is wider than a width of each of the grounding contact fingers, the mating region is further provided with a first conductive body and a second conductive body corresponding connected to the extending finger and the grounding layer and at an interval in the insertion direction.

In certain embodiments, the signal contact fingers provided on the first surface or the second surface of the mating region comprise a plurality of signal finger pairs, each of the signal finger pairs is formed by two adjacent ones of the signal contact fingers, each of two sides of each of the signal finger pairs in the longitudinal direction is provided with an adjacent one of the grounding contact fingers, only two adjacent ones of the grounding contact fingers are provided between two adjacent ones of the signal finger pairs, and two of the extending fingers corresponding to the two adjacent ones of the grounding contact fingers are connected in the longitudinal direction.

In certain embodiments, the mating region comprises a guiding portion located between the extending finger and the mating edge in the insertion direction, a thickness of the guiding portion in the lateral direction gradually becomes smaller along a direction from the extending finger toward the mating edge, the mating region comprises a plurality of grounding layers, the grounding layers comprise two first grounding layers and two second grounding layers, the two second grounding layers are located between the two first grounding layers in the lateral direction, the second grounding layers protrude toward the mating edge in the insertion direction relative to the first grounding layers and extend into the guiding portion.

In certain embodiments, each of the two first grounding layers is divided into a first portion and a second portion provided at an interval in the insertion direction, the first portion is provided to be farther away from the mating edge than the second portion, and a projection of each of the signal contact fingers in the lateral direction at least partially falls in a gap between the first portion and the second portion.

In certain embodiments, a ratio of a length of each of the signal contact fingers along the insertion direction to a distance between each of the signal contact fingers and the mating edge is less than or equal to 0.6.

In certain embodiments, the main body is provided with a foolproof portion in the insertion slot, the foolproof portion divides the insertion slot into a long slot and a short slot, the electrical connector comprises a shielding shell covering outside the main body, the shielding shell is provided with a plurality of guiding legs, the guiding legs comprise a plurality of first guiding legs, viewing along the insertion direction, the first guiding legs are provided to be opposite to the long slot in the lateral direction; the circuit board is provided with a plurality of conductive holes, the conductive holes comprise a plurality of first conductive holes, each of two opposite sides of each of the conductive pad groups in the longitudinal direction comprises a virtual boundary line, the first conductive holes are located between the virtual boundary lines of two adjacent ones of the conductive pad groups in the longitudinal direction, and the first guiding legs are accommodated in the first conductive holes.

In certain embodiments, the main body is provided with a foolproof portion in the insertion slot, the foolproof portion divides the insertion slot into a long slot and a short slot, viewing from the insertion direction, the conductive pad groups are provided to be opposite to the long slot in the lateral direction, the pair of signal conductive pads and the two grounding conductive pads in a same one of the conductive pad groups are arranged at equal intervals, in the longitudinal direction, a central distance between two adjacent ones of the conductive pad groups is greater than a central distance between two adjacent conductive pads of the same one of the conductive pad groups, and for the contact fingers and the conductive pad groups electrically connected to the terminal group, a virtual plane passing a center of two adjacent ones of the signal contact fingers arranged along the longitudinal direction is defined as a first central plane, and the first central plane is located between the pair of the signal conductive pads in the longitudinal direction.

Compared to the prior art, the present invention has the following beneficial effects:

A central distance between two of the signal contact fingers in contact with a same one of the differential terminal pairs is greater than a central distance between two of the signal conductive pads in contact with the same one of the differential terminal pairs, ensuring compatibility with the interval of the contact fingers of the electronic card in the previous version, and reducing the gap between the signal conductive pads in the same conductive pad group, thereby increasing the distance between two adjacent conductive pad groups, and reducing the issue of crosstalk interference of the electrical connector.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure.

Wherever possible, the same reference numbers are used throughout the drawings to refer to the same or like elements of an embodiment, and wherein:

FIG. 1 is a perspective view of a connector assembly according to certain embodiments of the present invention.

FIG. 2 is a perspective exploded view of the electrical connector in FIG. 1.

FIG. 3 is a partial enlarged view of a portion A in FIG. 2.

FIG. 4 is a partial sectional view of FIG. 2 showing only the internal structure of the body and sectioned along a direction.

FIG. 5 is a partial enlarged view of a portion B in FIG. 4.

FIG. 6 is a partial sectional view of FIG. 1, in which the electrical connector is sectioned along a direction for showing the shape of the separation ribs.

FIG. 7 is a partial enlarged view of a portion C in FIG. 6.

FIG. 8 is a top view of the electrical connector in FIG. 1.

FIG. 9 is a sectional view of FIG. 8 sectioned along the D-D direction.

FIG. 10 is a sectional view of FIG. 8 sectioned along the E-E direction.

FIG. 11 is a sectional view of FIG. 8 sectioned along the F-F direction.

FIG. 12 is a partial enlarged view of a portion G in FIG. 11.

FIG. 13 is a partial enlarged view of a portion H in FIG. 11.

FIG. 14 is a partial sectional view of FIG. 2 sectioned along a direction for showing the matching of the body and the insulating block.

FIG. 15 is a partial plain view of FIG. 2 showing only a terminal group and the insulating block.

FIG. 16 is a perspective view of a terminal group in FIG. 2.

FIG. 17 is a plain view showing only two terminal groups mating with the mating component after the mating component in FIG. 1 is inserted into the electrical connector.

FIG. 18 is a plain view of the two terminal groups in FIG. 17.

FIG. 19 is a partial enlarged view of a portion I in FIG. 18.

FIG. 20 is a partial sectional view in which the electrical connector in FIG. 1 is sectioned along a direction to show the conductive plastic and the ground terminals.

FIG. 21 is a partial plain view showing only the mating component in FIG. 1.

FIG. 22 is a sectional view sectioned along a direction after the mating component is inserted in the electrical connector.

FIG. 23 is a sectional view of the mating component sectioned along a direction to show the grounding layer.

FIG. 24 is a schematic view of the grounding contact fingers on two surfaces of the mating component in FIG. 1 being staggered.

FIG. 25 is a top view of the electrical connector in FIG. 1.

FIG. 26 is a partial plain view of an electrical connector in the prior art prior to mating with a mating component and a circuit board.

FIG. 27 is a plain view of the terminal group of the electrical connector in FIG. 26.

FIG. 28 is a chart showing the impedance analysis comparison between the connector assembly according to the present invention and the prior art from the circuit board to the mating component.

FIG. 29 is a chart showing the impedance analysis comparison between the connector assembly according to the present invention and the prior art from the mating component to the circuit board.

FIG. 30 is a chart showing the insertion loss analysis comparison between the connector assembly according to the present invention and the prior art.

FIG. 31 is a chart showing the return loss analysis comparison between the connector assembly according to the present invention and the prior art.

FIG. 32 is a chart showing the near-end crosstalk analysis comparison between the connector assembly according to the present invention and the prior art.

FIG. 33 is a chart showing the far-end crosstalk analysis comparison between the connector assembly according to the present invention and the prior art.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

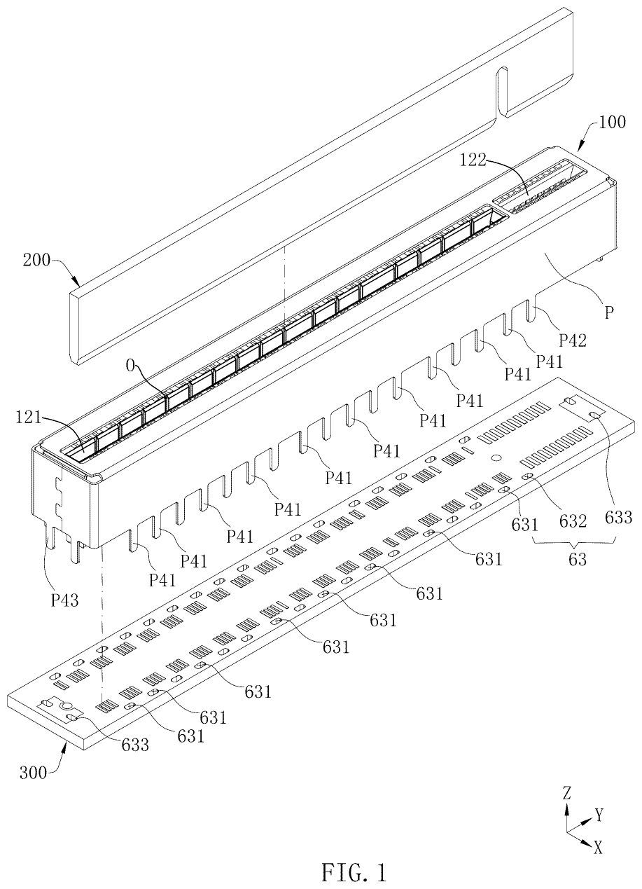

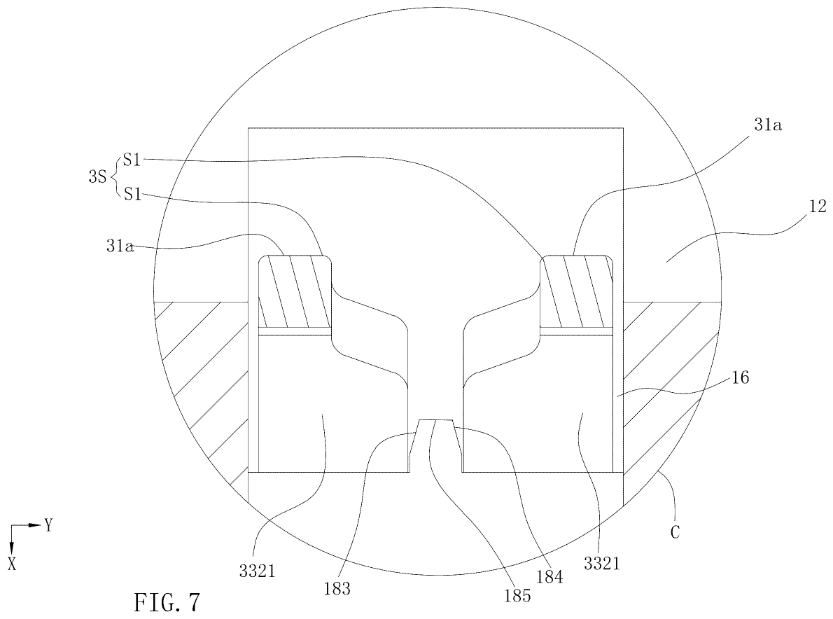

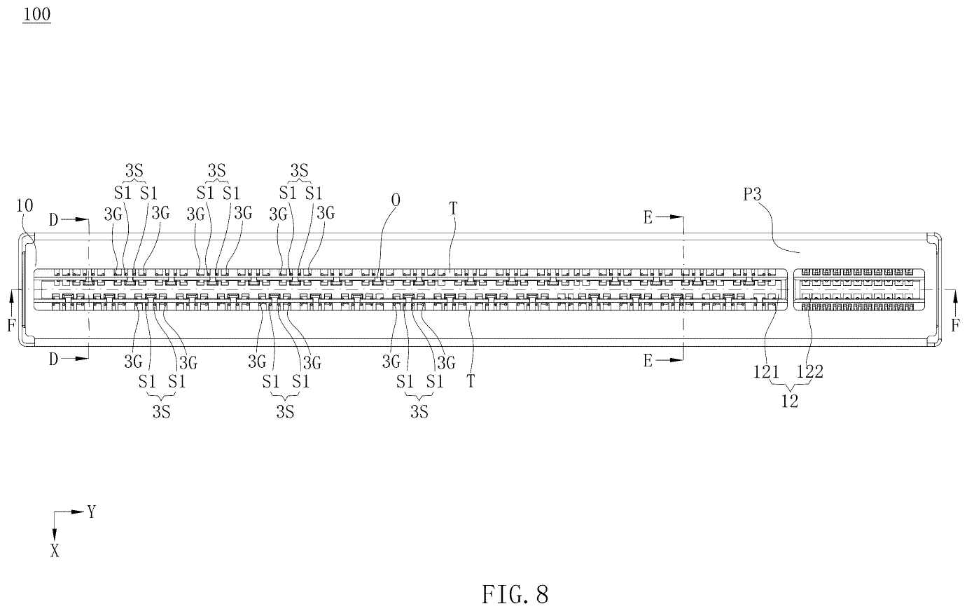

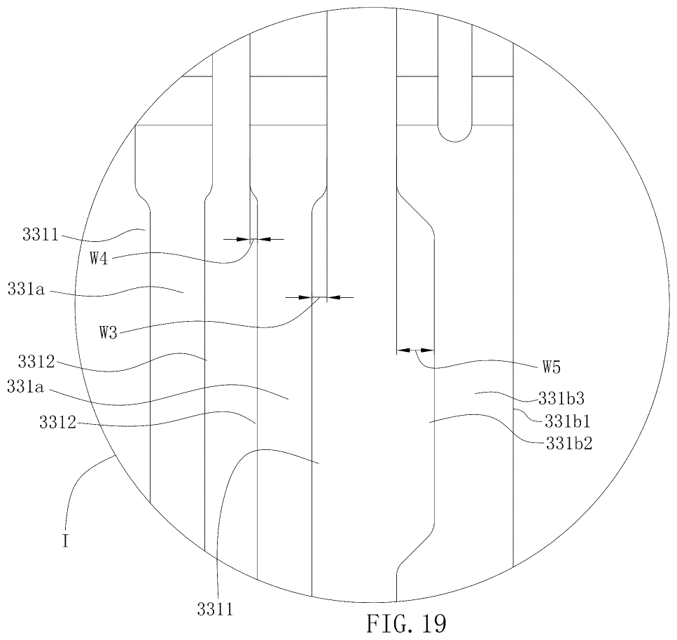

The description will be made as to the embodiments of the present invention in conjunction with the accompanying drawings in FIGS. 1-33. In accordance with the purposes of this invention, as embodied and broadly described herein, this invention, in one aspect, relates to an electrical connector and a connector assembly.

For convenience of understanding, the present invention defines a lateral direction (the X-axis), a longitudinal direction (the Y-axis) and an insertion direction (the Z-axis), and the three directions are perpendicular to one another. In the disclosure, the lateral direction is a front-rear direction, the longitudinal direction is a left-right direction, and the insertion direction is a vertical direction. In other embodiments, the lateral direction, the longitudinal direction and the insertion direction may be selected among the front-rear direction, the left-right direction and the vertical direction according to the need, as long as the three directions are perpendicular to one another.

As shown in FIG. 1, the connector assembly according to certain embodiments of the present invention includes an electrical connector 100, a mating component 200 and a circuit board 300. The electrical connector 100 is provided to mate with the mating component 200 along the insertion direction and is mounted to the circuit board 300 along the insertion direction. In the present invention, the electrical connector 100 is described using the PCIe 7.0 specification as an example.

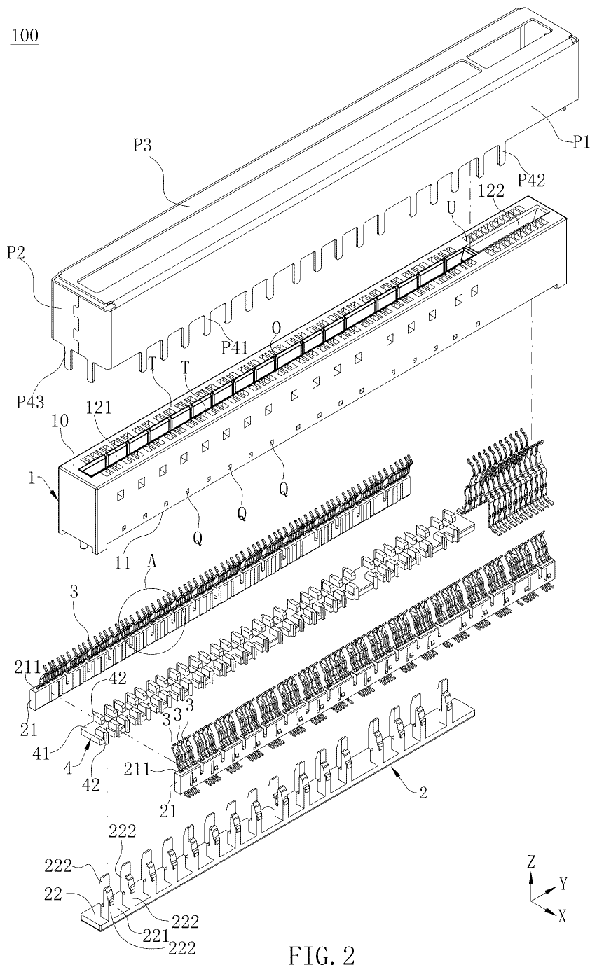

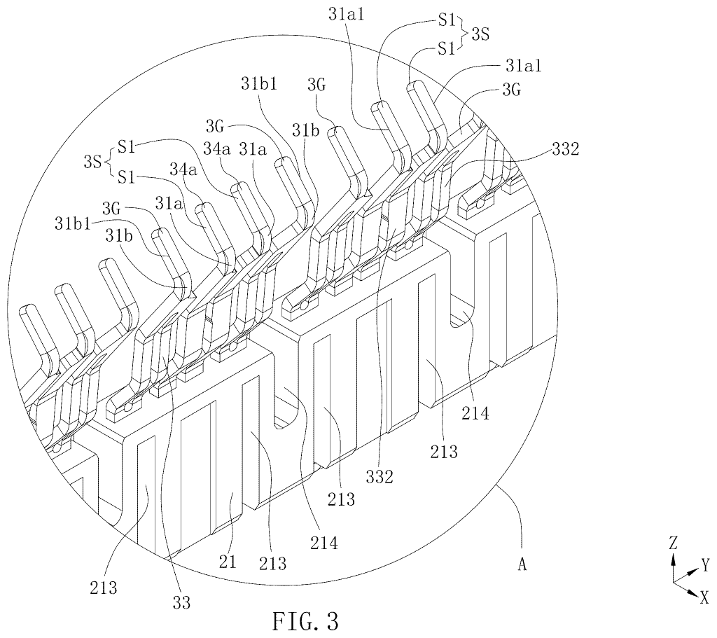

As shown in FIG. 2 and FIG. 3, the electrical connector 100 includes a main body 1, a terminal seat 2 mounted on the main body 1, a plurality of conductive terminals 3 provided in the main body 1, a conductive plastic 4 provided in the main body 1 and a shielding shell P covering outside the main body 1. The conductive terminals 3 are firstly fixedly provided on the terminal seat 2 and are then mounted in the main body 1 together with the terminal seat 2. The conductive terminals 3 are provided in two rows in the lateral direction, and the conductive terminals 3 in each row are arranged along the longitudinal direction. The conductive terminals 3 may be used to be connected to a cable (not shown). The electrical connector 100 further includes a plurality of additional terminals (not numbered), provided at a side of the terminal seat 2 in the longitudinal direction and assembled to the main body 1. The additional terminals are used to transmit power. In other embodiments, it is possible that some of the conductive terminals 3 are fixed to the terminal seat 2, and some are fixed to the main body 1.

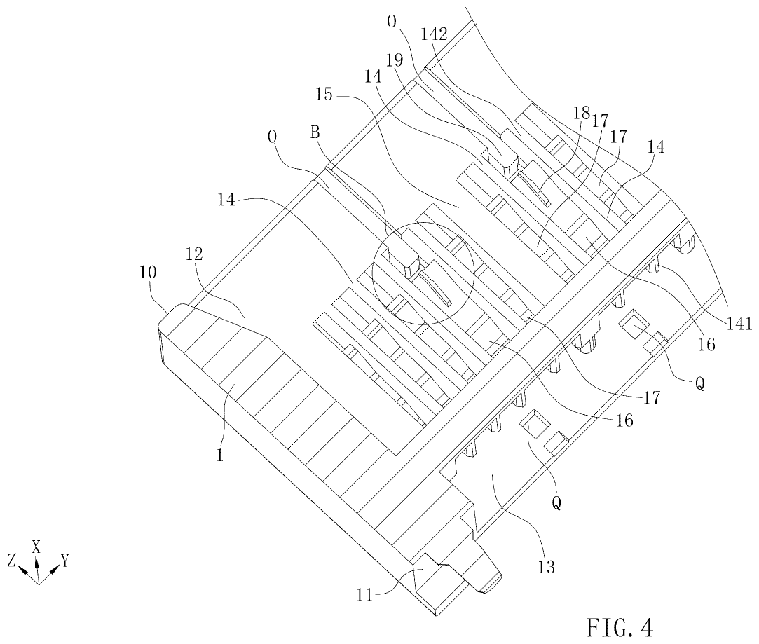

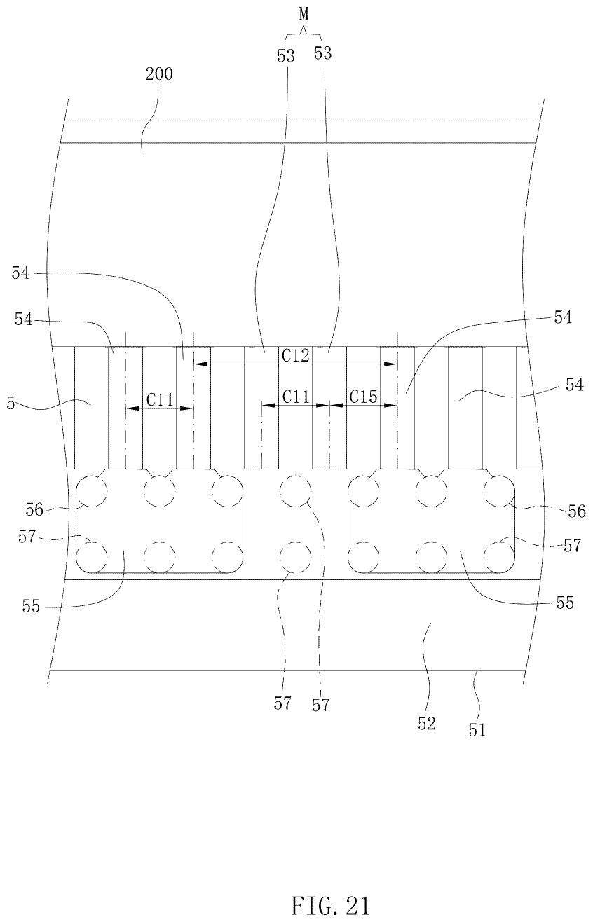

As shown in FIG. 2 and FIG. 4, the main body 1 is integrally formed by a plastic material and has a mating surface 10 and a mounting surface 11 opposite to each other along the insertion direction, an insertion slot 12 concavely provided on the mating surface 10, a foolproof portion U located in the insertion slot 12, two side walls T located at two lateral sides of the insertion slot 12 and a mounting cavity 13 concavely provided on the mounting surface 11. The insertion slot 12 is divided by the foolproof portion U into a long slot 121 and a short slot 122. The insertion slot 12 is used for insertion of the mating component 200 therein. The mating component 200 is an electronic card (referring to FIG. 1 and FIG. 21), and the conductive terminals 3 in two rows are provided at the two sides of the insertion slot 12 in the lateral direction. In the present embodiment, the conductive terminals 3 are provided to correspond to the long slot 121, and the additional terminals (not numbered) are provided to correspond to the short slot 121. In other embodiments, the mating component 200 may be a cable connector, or may be other components or structures.

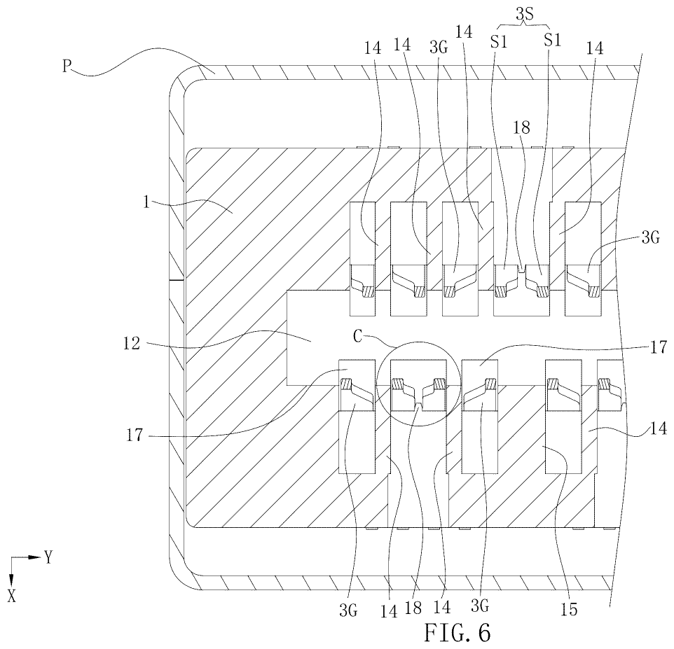

As shown in FIG. 4 and FIG. 6, the main body 1 further has a plurality of columns 14, a plurality of separation walls 15, a plurality of signal slots 16, a plurality of grounding slots 17, a plurality of separation ribs 18, a plurality of protruding ribs 19 and a plurality of grooves 0. Each groove 0 is concavely formed on a surface of each side wall T adjacent to the insertion slot 12, thus reducing the plastic of the side wall T around the corresponding conductive terminal 3. In certain embodiments, each side wall T is provided with the columns 14, the separation walls 15, the signal slots 16, the grounding slots 17, the separation ribs 18, the protruding ribs 19 and the grooves 0 at the positions corresponding to the long slot 121, and the columns 14 and the separation walls 15 on the same side wall T are provided at intervals along the longitudinal direction.

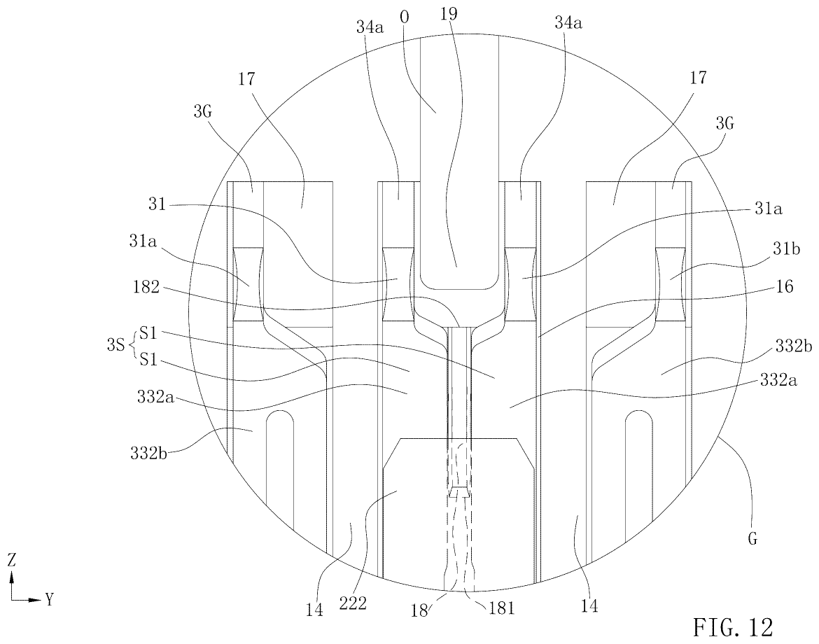

As shown in FIG. 4 and FIG. 6, the columns 14 are located at two lateral sides of the insertion slot 12. That is, the columns 14 are provided in two rows in the lateral direction, and the columns 14 in each row are arranged along the longitudinal direction. A signal slot 16 is formed between two adjacent columns 14 at the same side of the insertion slot 12, and a grounding slot 17 is formed between a column 14 and its adjacent separation wall 15. A width of the separation wall 15 in the longitudinal direction is greater than a width of the column 14. Specifically, the signal slots 16 and the grounding slots 17 at the same side of the insertion slot 12 are alternately arranged, and the signal slots 16 and the separation ribs 18 are one-to-one correspondingly provided. That is, each signal slot 16 is provided with a corresponding separation rib 18 therein, and each separation rib 18 extends along the insertion direction and is protruding provided in the corresponding signal slot 16 in the lateral direction. The protruding ribs 19 and the separation ribs 18 are one-to-one correspondingly provided in the insertion direction, and each protruding rib 19 protrudes toward a corresponding signal slot 16. The protruding ribs 19 are located closer to the mating surface 10 relative to the separation ribs 18 and are provided at intervals with the corresponding separation ribs 18. A dimension of each protruding rib 19 in the longitudinal direction is greater than a dimension of each separation rib 18 in the longitudinal direction (referring to FIG. 12). The grooves 0 and the protruding ribs 19 are one-to-one correspondingly provided in the lateral direction, and a dimension of each groove 0 in the longitudinal direction is less than or equal to the dimension of each protruding rib 19 in the longitudinal direction.

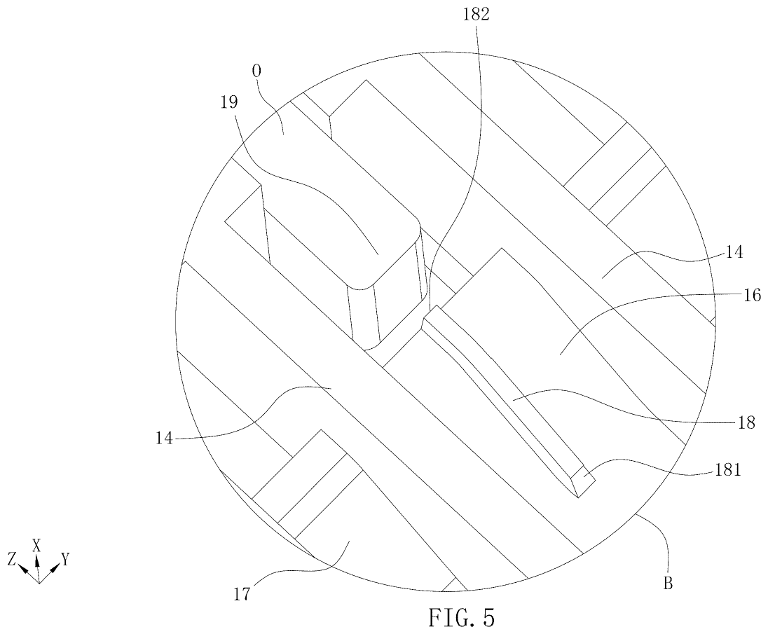

As shown in FIG. 5 and FIG. 6, for the side of the insertion slot 12, the separation ribs 18 are provided to be farther away from the insertion slot 12 relative to the columns 14 in the lateral direction, and a dimension of each separation rib 18 in the longitudinal direction is less than a dimension of each column 14 in the longitudinal direction (referring to FIG. 12). That is, each separation rib 18 is narrower than each column 14 in the longitudinal direction.

As shown in FIG. 4, each column 14 has a second far end 141 and a second near end 142 opposite to each other along the insertion direction. Along the insertion direction, one end of each column 14 away from the mating surface 10 is defined as the second far end 141, and one end of each column 14 adjacent to the mating surface 10 is defined as the second near end 142.

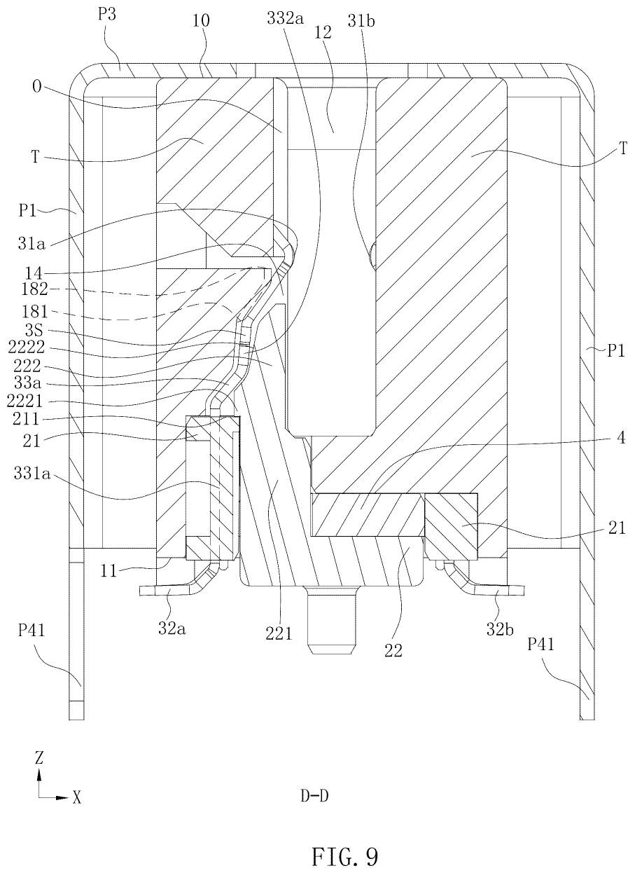

As shown in FIG. 4 and FIG. 5, each separation rib 18 has a first far end 181 and a first near end 182 opposite to each other along the insertion direction. Along the insertion direction, one end of each separation rib 18 away from the mating surface 10 is defined as the first far end 181, and one end of each separation rib 18 adjacent to the mating surface 10 is defined as the first near end 182. The first near end 182 is provided to be closer to the insertion slot 12 than the first far end 181 in the lateral direction (referring to FIG. 5 and FIG. 9).

As shown in FIG. 5 to FIG. 7, each separation rib 18 further has a connecting surface 185 and a first side surface 183 and a second side surface 184 opposite to each other in the longitudinal direction. The first side surface 183 and the second side surface 184 extend obliquely toward a side adjacent to the insertion slot 12 in the lateral direction and are respectively connected to the connecting surface 185.

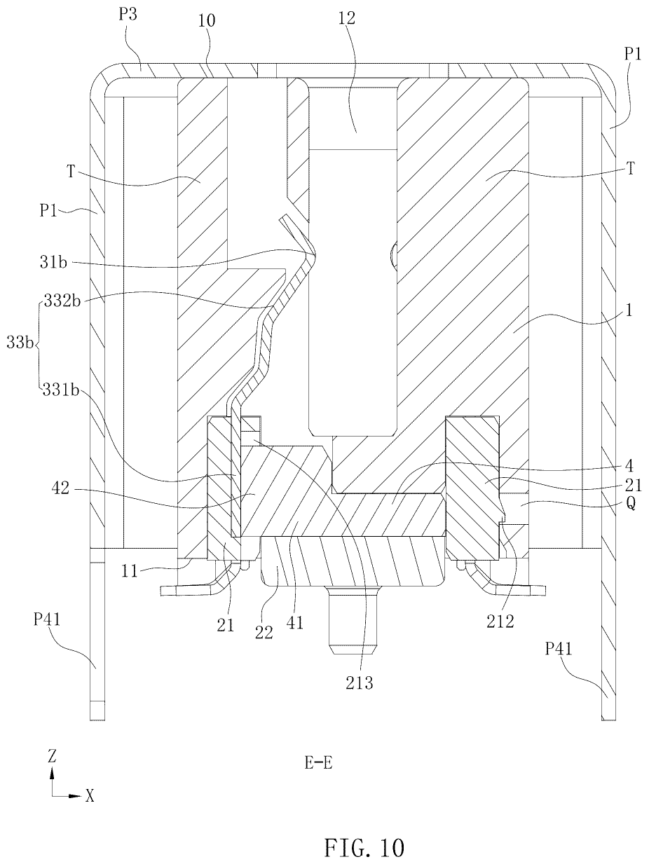

As shown in FIG. 2 and FIG. 10, the main body 1 further has a plurality of clamping slots Q arranged along the longitudinal direction at the two lateral sides of the insertion slot 12. The clamping slots Q are located at two sides of the mounting cavity 13 in the lateral direction, and the clamping slots Q run through the main body 1 in the lateral direction.

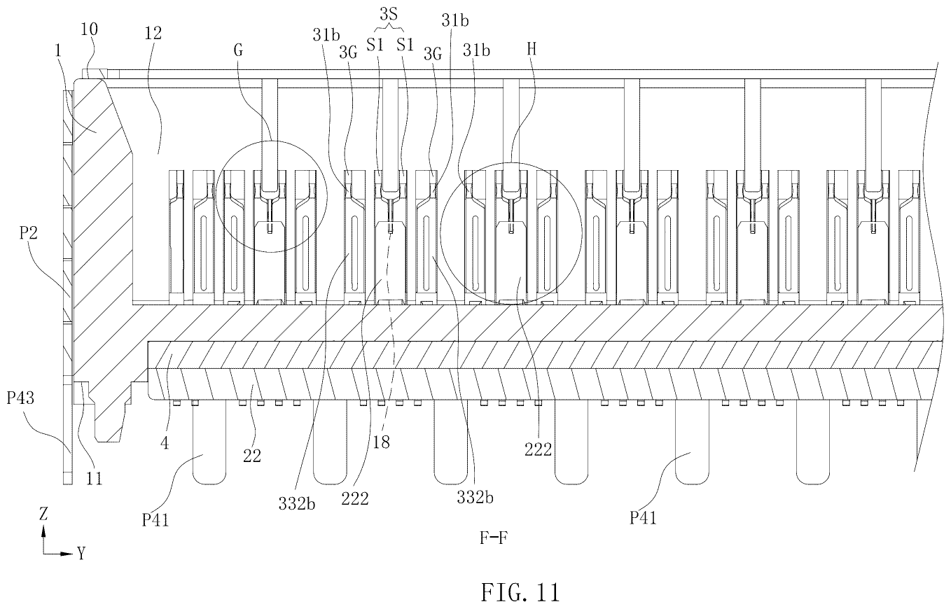

As shown in FIG. 4, FIG. 9 and FIG. 11, each groove 0 is formed by recessing along the lateral direction from a side of the corresponding side wall T adjacent to the insertion slot 12, and the grooves 0 run through the mating surface 10 along the insertion direction. A surface of each groove 0 farthest away from the insertion slot 12 in the lateral direction is located closer to the insertion slot 12 than the connecting surface 185 of each separation rib 18.

As shown in FIG. 1 and FIG. 2, the shielding shell P is made of a metal material and covers the main body 1. The shielding shell P includes two longitudinal side plates P1 located at two sides of the main body 1 in the lateral direction, two lateral side plates P2 located at two sides of the main body 1 in the longitudinal direction, a top plate P3 connected to the longitudinal side plates Pl and a plurality of guiding legs P4 conductively connected to the circuit board 300. The guiding legs P4 include a plurality of first guiding legs P41, a plurality of second guiding legs P42 and a plurality of third guiding legs P43. The first guiding legs P41 and the second guiding legs P42 extend from the longitudinal side plates P1 toward the circuit board 300, and the third guiding legs P43 extend from the lateral side plates P2 toward the circuit board 300. Viewing from the insertion direction, the first guiding legs P41 are provided to be opposite to the long slot 121 in the lateral direction, the second guiding legs P42 are provided to be opposite to the foolproof portion U in the lateral direction, the third guiding legs P43 are provided to be opposite to the insertion slot 12 in the longitudinal direction, and the top plate P3 covers the mating surface 10.

As shown in FIG. 2 and FIG. 9, the terminal seat 2 includes two insulating blocks 21 and an insulating member 22 located between the two insulating blocks 21 along the lateral direction. The two insulating blocks 21 and the insulating member 22 are all assembled from a side of the mounting surface 11 and are accommodated in the mounting cavity 13, and each insulating block 21 is embedded with the conductive terminals 3 in one row.

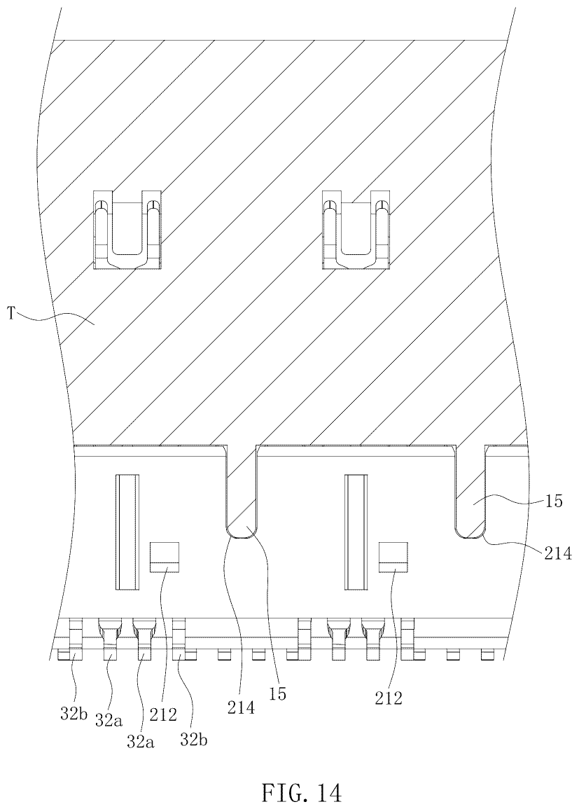

As shown in FIG. 2, FIG. 10 and FIG. 14, each insulating block 21 has an end surface 211, a plurality of clamping blocks 212, a plurality of inner slots 213 and a plurality of notch portions 214. The end surface 211 is provided to face toward a side of the mating surface 10 in the insertion direction. A side of each of the two insulating blocks 21 away from each other is provided with the clamping blocks 212, and the clamping blocks 212 are one-to-one correspondingly accommodated in the clamping slots Q and are engaged and connected to the clamping slots Q. A side of each of the two insulating blocks 21 facing toward each other is provided with the inner slots 213, and each inner slot 213 runs through the corresponding insulating block 21 toward the mounting surface 11 along the insertion direction. The notch portions 214 are concavely provided on the end surface 211 toward the mounting surface 11. The notch portions 214 are one-to-one correspondingly engaged with the separation walls 15, thereby positioning the insulating blocks 21 to the main body 1.

As shown in FIG. 2 and FIG. 9, the insulating member 22 is integrally formed by a plastic material. The insulating member 22 has a base seat 221 and a plurality of insulating protrusions 222 connected to the base seat 221. The base seat 221 is clamped between the two insulating blocks 21 and is accommodated in the mounting cavity 13. The insulating protrusions 222 are formed by extending toward the mating surface 10 from the base seat 221 along the insertion direction. The insulating protrusions 222 one-to-one protrude into the signal slots 15, and the insulating protrusions 222 do not protrude into the insertion slot 12. Each insulating protrusion 222 is provided with a stopping block 2221 protruding out of the base seat 221 along the lateral direction. The insulating protrusions 222 are provided in two rows in the lateral direction. The insulating protrusions 222 in the two rows are located at two sides of the insertion slot 12 in the lateral direction, and the insulating protrusions 222 in each row are arranged along the longitudinal direction. The stopping blocks 2221 are provided to be closer to the mating surface than the end surface 211 in the insertion direction, and each stopping block 2221 is clamped at a side of a corresponding insulating block 21 adjacent to the mating surface 10. That is, each stopping block 2221 is clamped to the corresponding end surface 211. Thus, the insulating member 22 may be fixed to the main body 1 through the insulating blocks 21. Each insulating protrusion 222 is provided with a matching surface 2222, and a portion of the matching surface 2222 extends on the corresponding stopping block 2221.

As shown in FIG. 9 and FIG. 12, the insulating protrusions 222 are located closer to the mating surface 10 relative to the first far end 181 and are accommodated in the signal slots 16, and the insulating protrusions 222 shield the first far end 181 in the lateral direction.

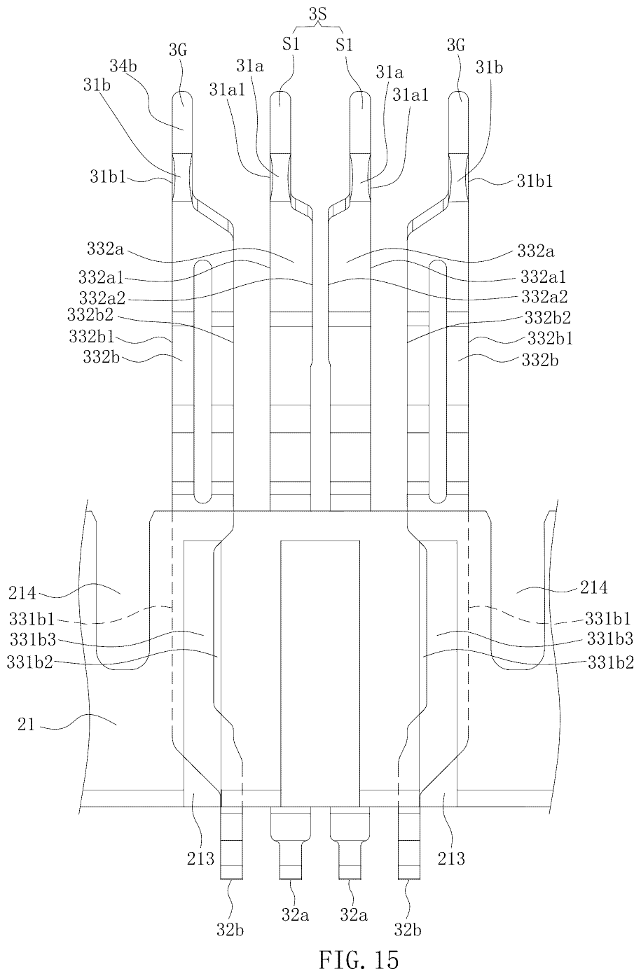

As shown in FIG. 11 and FIG. 15, the conductive terminals 3 in each row include a plurality of differential terminal pairs 3S and a plurality of ground terminals 3G. Two sides of each differential terminal pair 3S in the longitudinal direction are respectively distributed with the ground terminals 3G adjacent thereto. Each differential terminal pair 3S and the two ground terminals 3G adjacent to the two sides of each differential terminal pair 3S form a terminal group R, and the differential terminal pairs 3S are used to transmit differential signals. In other embodiments, the quantity of the differential terminal pairs 3S being provided in the conductive terminals 3 in each row may be determined according to the need, which may be one, two or more.

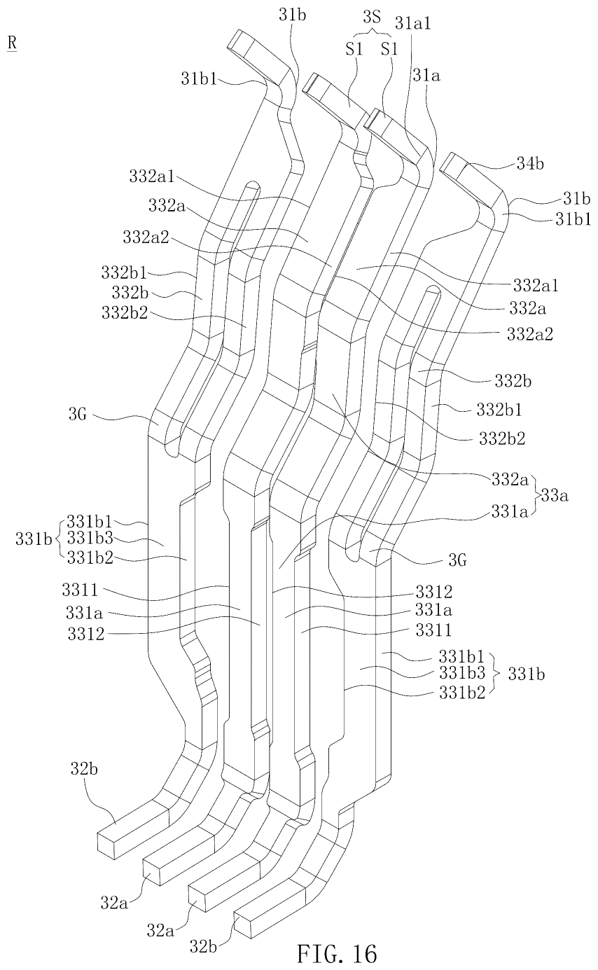

As shown in FIG. 15 and FIG. 16, each differential terminal pair 3S includes two signal terminals S1 adjacent to each other. Each signal terminal S1 includes a first contact portion 31a, a first conductive portion 32a, a first middle portion 33a connected between the first contact portion 31a and the first conductive portion 32a and a first tail portion 34a connected to the first contact portion 31a. The first middle portion 33a includes a first body portion 331a and a first connecting arm 332a connected to each other. The first connecting arm 332a is connected between the first body portion 331aand the first contact portion 31a, and the first contact portion 31a is exposed to the long slot 121 of the insertion slot 12 in the lateral direction.

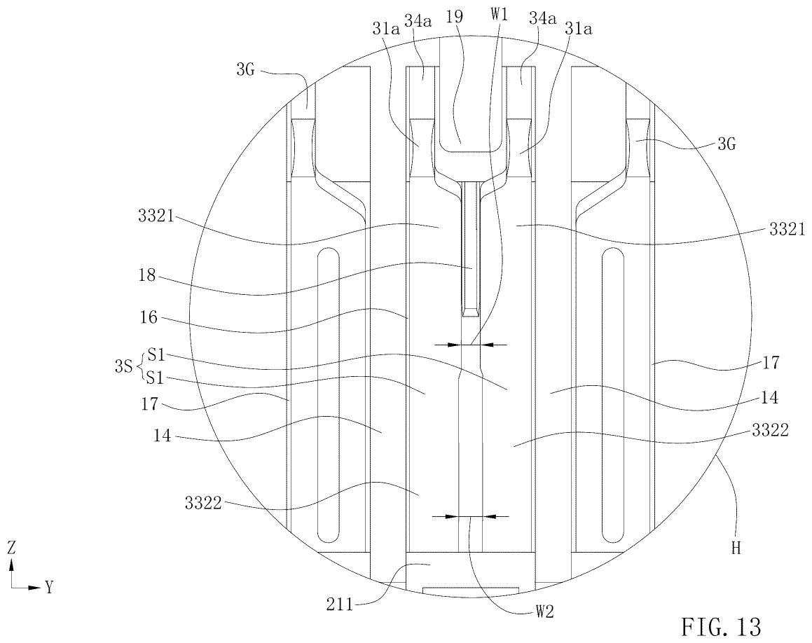

As shown in FIG. 13, the first connecting arm 332a includes a first section 3321 and a second section 3322 connected to each other. The first section 3321 is connected to the corresponding first contact portion 31a, and the second section 3322 is connected to the corresponding first body portion 331a. A distance W1 between the two first sections 3321 of each differential terminal pair 3S in the longitudinal direction is less than a distance W2 between the two second sections 3322 of each differential pair 3S in the longitudinal direction.

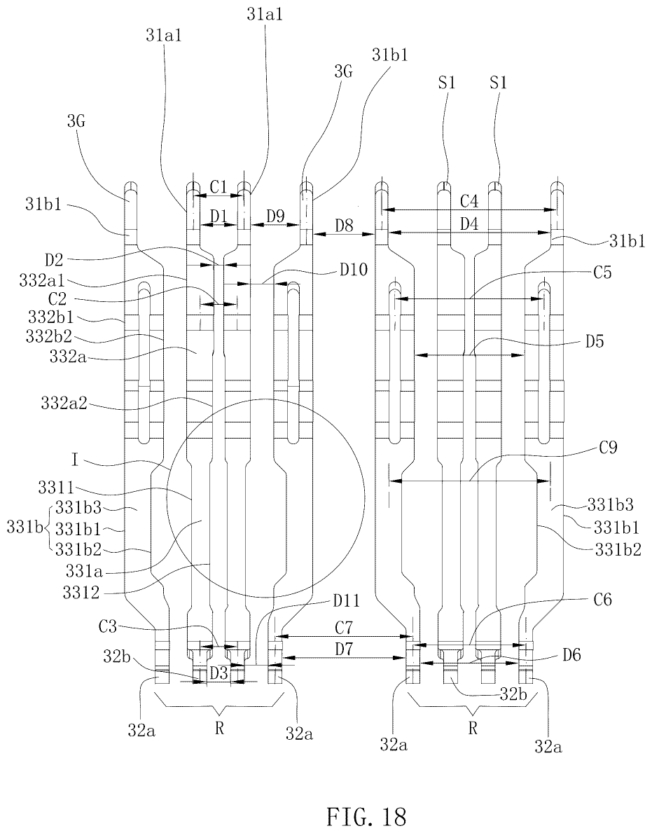

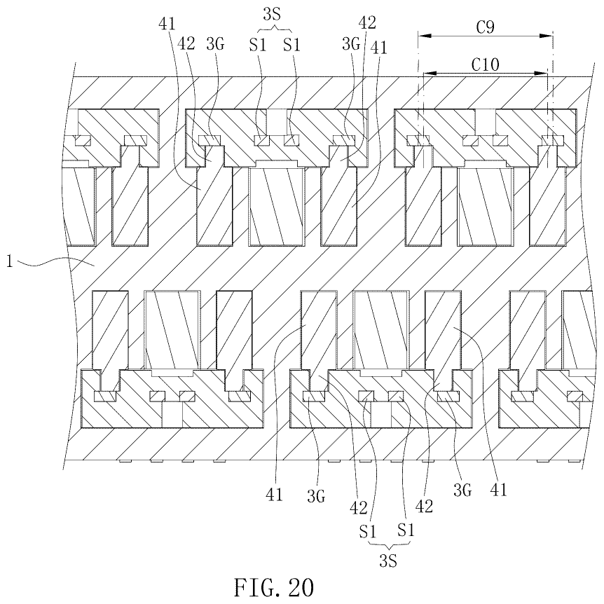

As shown in FIG. 16, FIG. 18 and FIG. 20, for the same differential terminal pair 3S, a side of each of the two first contact portions 31a away from each other in the longitudinal direction has a first contact side edge 31a1, and a side of each of the two first connecting arms 332a away from each other in the longitudinal direction has a first connecting side edge 332a1. The first contact side edge 31a1 and the first connecting side edge 332a1 of the same signal terminal S1 are located on a same plane perpendicular to the longitudinal direction. Each of the two first connecting arms 332a has a first connecting side edge 332a1 at the side away from each other and a second connecting side edge 332a2 at the side adjacent to each other in the longitudinal direction. The first body portion 331a includes a first retracted portion 3311 retracted relative to the corresponding first connecting side edge 332a1 in the longitudinal direction and a second retracted portion 3312 retracted relative to the second connecting side edge 332a2 in the longitudinal direction. A retraction distance W3 of the first retracted portion 3311 is greater than a retraction distance W4 of the second retracted portion 3312. A central distance C1 between the two first contact portions 31a is greater than a central distance C2 between the two first connecting arms 332a. The central distance C1 between the two first contact portions 31a is greater than a central distance C3 between the two first conductive arms. The central distance C2 between the two first connecting arms 332a is greater than the central distance C3 between the two first conductive arms. A distance D1 between the two first contact portions 31a is greater than a distance D2 between the two first connecting arms 332a, and the distance D1 between the two first contact portions 31a is greater than a distance D3 between the two first conductive portions.

As shown in FIG. 10 and FIG. 16, each ground terminal 3G includes a second contact portion 31b, a second conductive portion 32b, a second middle portion 33b connected between the second contact portion 31b and the second conductive portion 32b and a second tail portion 34b connected to the second contact portion 31b. The second middle portion 33b includes a second body portion 331b and a second connecting arm 332b connected to each other. The second connecting arm 332b is connected between the second body portion 331b and the second contact portion 31b, and the second contact portion 31b is exposed to the long slot 121 of the insertion slot 12 in the lateral direction.

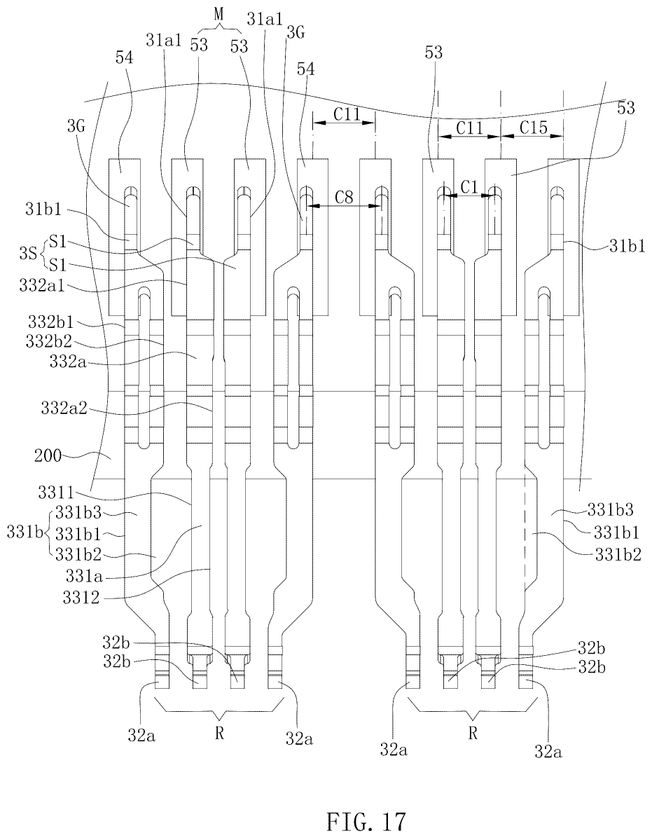

As shown in FIG. 17 and FIG. 18, for the two ground terminals 3G of the same terminal group R, a side of each second contact portion 31b away from the differential terminal pair 3S in the longitudinal direction has a first contact edge 31b1. A side of each second connecting portion 332b away from the differential terminal pair 3S in the longitudinal direction has a first connecting edge 332b1. A side of each second body portion 331b away from the differential terminal pair 3S in the longitudinal direction has a first body edge 331b1. The first contact edge 31b1, the first connecting edge 332b1 and the first body edge 331b1 are sequentially connected and are all located on a same plane perpendicular to the longitudinal direction. A side of each second connecting arm 332b adjacent to the differential terminal pair 3S in the longitudinal direction has a second connecting edge 332b2. The second body portion 331b is provided with a retracted notch 331b2 recessed inward relative to the plane on which the second connecting edge 332b2 is located, such that the second body portion 331b is away from the differential terminal pair 3S. A retraction distance W5 of the retracted notch 331b2 relative to the plane on which the second connecting edge 332b2 is located is greater than or equal to 0.2 mm. A portion of the second body portion 331b located at a side of the retracted notch 331b2 in the longitudinal direction is defined as a narrow portion 331b3. A central distance C4 between the two second contact portions 31b is greater than a central distance C5 between the two second connecting arms 332b. The central distance C4 between the two second contact portions 31b is greater than a central distance C6 between the two second conductive portion 32b. The central distance C5 between the two second connecting arms 332b is greater than the central distance C6 between the two second conductive portion 32b. A distance D4 between the two second contact portion 31b is greater than a distance D5 between the two second connecting arms 332b, and the distance D4 between the two second contact portion 31b is greater than a distance D6 between the two second conductive portion 32b.

As shown in FIG. 18, for the two ground terminals 3G provided to be adjacent to each other between two adjacent terminal groups R, a distance D7 between the two conductive portions 32b is greater than a distance D8 between the two second contact portions 31b, and a central distance C7 between the two second conductive portions 32b is greater than a central distance C8 between the two second contact portions 31b. A distance D9 between the first contact portion 31a and the second contact portion 31b is greater than a distance D10 between the first connecting arm 332a and the second connecting arm 332b, and the distance D9 between the first contact portion 31a and the second contact portion 31b is greater than a distance D11 between the first conductive portion and the second conductive portion 32b.

As shown in FIG. 10 and FIG. 15, the first body portion 331a and the second body portion 331b are both fixedly provided in the corresponding insulating blocks 21. The first connecting arm 332a is formed by bending and extending toward a side close to the insertion slot 12 in the lateral direction relative to the first body portion 331a, and the second connecting arm 332b is formed by bending and extending toward a side close to the insertion slot 12 in the lateral direction relative to the second body portion 331b. The first connecting arm 332a and the second connecting arm 332b both protrude toward a side close to the mating surface 10 in the insertion direction relative to the end surface 221, and the first connecting arm 332a and the second connecting arm 332b are both elastic arm structures with elasticity. That is, the first connecting arm 332a and the second connecting arm 332b protrude relative to the end surface 211. The first conductive portion 32a and the second conductive portion 32b protrude out of the corresponding insulating blocks 21 from a side away from the end surface 211. The inner slot 213 correspondingly exposes the second body portion 331b. The retracted notch 331b2 is at least partially exposed to the inner slot 213.

As shown in FIG. 12, the differential terminal pairs 3S are accommodated in the signal slots 16, and the ground terminals 3G are accommodated in the grounding slot 17. Thus, one of the columns 14 is provided between the differential terminal pair 3S and its adjacent ground terminal 3G. Specifically, the signal slot 16 accommodates at least a portion of the two first connecting arms 332a of the differential terminal pair 3S. One of the separation ribs 18 is provided between the two first connecting arms 332a of the differential terminal pair 3S, and the separation rib 18 is located between the two first sections 3321 of the differential terminal pair 3S in the longitudinal direction. The first far end 181 is closer to the mating surface 10 than the end surface 211 and the second far end 141 in the insertion direction. A distance between the first far end 181 and the end surface 211 in the insertion direction is greater than the dimension of each separation rib 18 in the insertion direction.

As shown in FIG. 9, the insulating protrusions 222 correspondingly protrude into the signal slots 16. The insulating protrusions 222 are located between the insertion slot 12 and the first connecting arms 332a of the corresponding differential terminal pair 3S in the lateral direction. That is, viewing along the lateral direction, the two connecting arms 332a of the differential terminal pair 3S both partially overlap with one of the corresponding insulating protrusions 222. The matching surface 2222 is provided toward a side facing the first connecting arms 332a of the corresponding differential terminal pair 3S. The shape of the matching surface 2222 matches the first connecting arms 332a of the corresponding differential terminal pair 3S, such that a distance between each first connecting arm 332a of the differential terminal pair 3S and the matching surface 2222 in the lateral direction is relative uniform from an overall perspective, thus facilitating the adjustment of the characteristic impedance. Each stopping block 2221 is located between the corresponding first body portion 331a and the corresponding first contact portion 31a in the lateral direction. The two first tail portions 34a of the differential terminal pair 3S are separated by a corresponding protruding rib 19 in the longitudinal direction.

As shown in FIG. 2, the conductive plastic 4 includes a base body 41 and a plurality of extending portions 42 connected to the base body 41, and the extending portions 42 are arranged in two rows in the lateral direction.

As shown in FIG. 10 and FIG. 20, the conductive plastic 4 is fixedly connected to the insulating member 22 and is clamped between the two insulating blocks 21. Each extending portion 42 is provided to be closer to the mating surface 10 than the base body 41 in the insertion direction, and the base body 41 is provided to be closer to the mating surface 10 than the base seat 221. The insulating protrusions 222 protrude out of a side of the base body 41 adjacent to the mating surface 10 in the insertion direction. The extending portions 42 protrude into the inner slot 213 in the lateral direction and are provided corresponding to the ground terminals 3G, such that the conductive plastic 4 is electrically connected to the ground terminals 3G. Specifically, each extending portion 42 is in contact with the corresponding ground terminal 3G. In other embodiments, a small gap may exist between each extending portion 42 and the corresponding ground terminal 3G, which may facilitate electrical connection therebetween. For the two ground terminals 3G at the two sides of the same differential terminal pair 3S, a central distance C9 between the two narrow portions 331b3 is greater than a central distance C10 between the two corresponding extending portions 42.

As shown in FIG. 9 and FIG. 10, in the present embodiment, the assembling method of the electrical connector 100 is: firstly, the conductive terminals 3 in the two rows are molded in the two insulating blocks 21 to form two molding members, and the two molding members are assembled in the mounting cavity 13 upward from bottom thereof, where the molding members are engaged in the clamping slots Q of the main body 1 through the clamping blocks 212 of the insulating blocks 21, thereby fixing the insulating blocks 21 to the main body 1. Then, the conductive plastic 4 is mounted in the mounting cavity 13 from a side of the mounting surface 11, where the conductive plastic 4 is limited between the two insulating blocks 21 by protruding the extending portions 42 into the corresponding inner slots 213. Finally, the insulating member 22 is assembled in the mounting cavity 13 from the side of the mounting surface 11, where the stopping blocks 2221 are located at a side of the corresponding end surface 211 adjacent to the mating surface 10 and are engaged to the end surface 211, thereby preventing the insulating member 22 from detaching downward from the main body 1, and the base seat 221 holds the base body 41 to prevent the conductive plastic 1 from detaching downward from the mounting cavity 13.

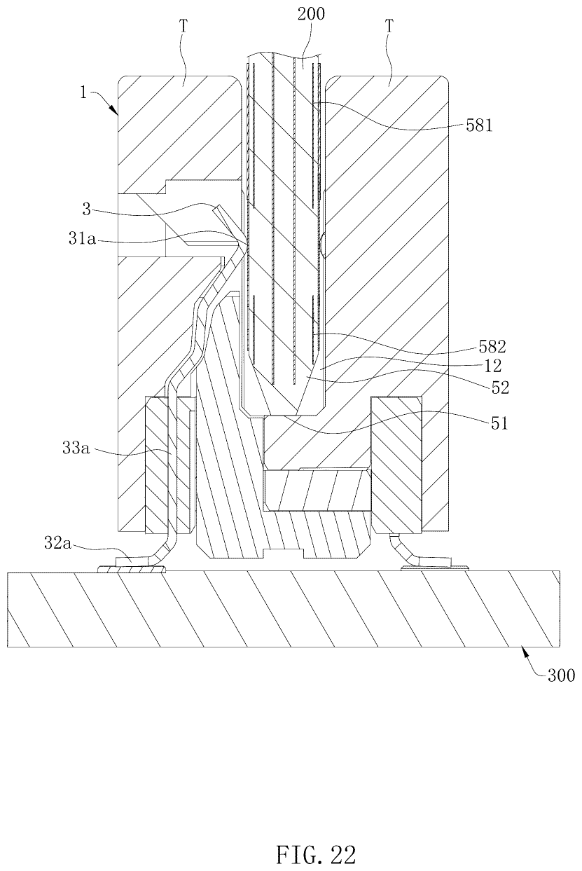

As shown in FIG. 1, FIG. 21 and FIG. 22, the mating component 200 includes a mating region 5 inserted in the insertion slot 12. The mating region 5 has a first surface 5a and a second surface 5b provided to be opposite to each other in the lateral direction, a mating edge 51 provided to be adjacent to the bottom surface of the insertion slot 12 in the insertion direction and a guiding portion 52 used to guide the mating region 5 to be inserted into the insertion slot 12.

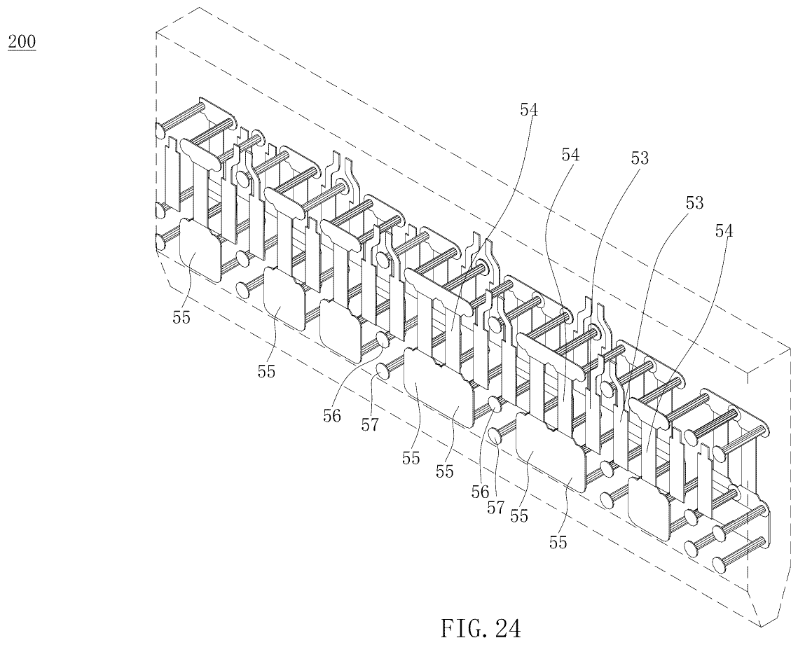

As shown in FIG. 21 and FIG. 24, the first surface 5a and the second surface 5b are both provided with a plurality of contact fingers arranged at equal intervals along the longitudinal direction. The contact fingers include a plurality of signal contact fingers 53 and a plurality of grounding contact fingers 54. The first contact portion 31a is in contact with a corresponding signal contact finger 53, and the second contact portion 31b is in contact with a corresponding grounding contact finger 54. One side of each grounding contact finger 54 close to the mating edge 51 along the insertion direction is connected to an extending finger 55, and the extending finger 55 is provided with a first conductive body 56 and a second conductive body 57 at an interval in the insertion direction. The grounding contact fingers 54 on the first surface 5a and the grounding contact fingers 54 on the second surface 5b are staggered to each other along the longitudinal direction. The guiding portion 52 is located between the extending finger 55 and the mating edge 51 in the insertion direction, and a thickness of the guiding portion 52 in the lateral direction gradually becomes smaller along a direction from the extending finger 55 toward the mating edge 51.

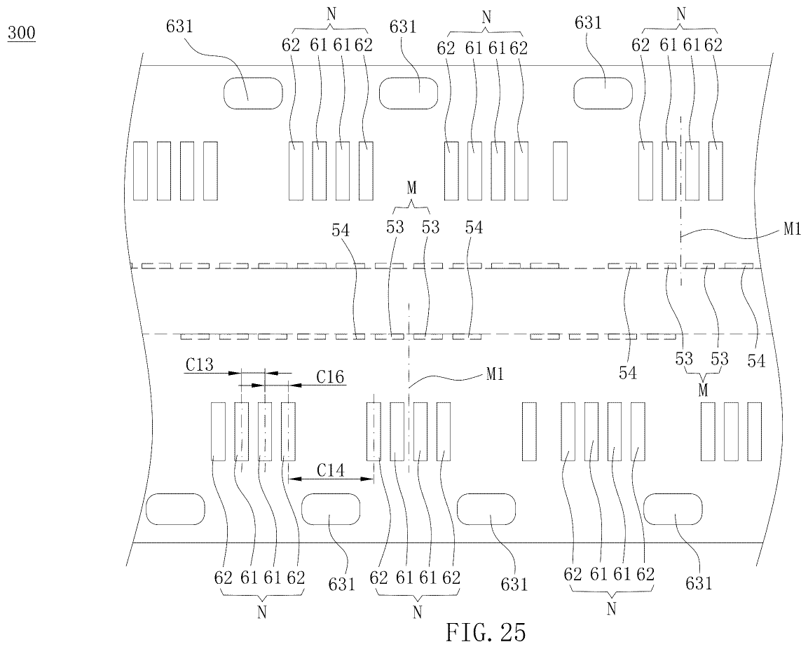

As shown in FIG. 21, for one of the first surface 5a and the second surface 5b, a width of each extending finger 55 in the longitudinal direction is wider than a width of each grounding contact finger 54. Each extending finger 55 is correspondingly provided with two first conductive bodies 56 provided at an interval in the longitudinal direction and two second conductive bodies 57 provided at an interval in the longitudinal direction. The first conductive bodies 56 and the second conductive bodies 57 are respectively provided to be staggered to the corresponding grounding contact fingers 54 in the insertion direction. The first conductive bodies 56 and the second conductive bodies 57 run through the mating component 200 in the lateral direction and are exposed to the first surface 5a and the second surface 5b. The first conductive bodies 56 are arranged at equal intervals along the longitudinal direction, and the second conductive bodies 57 are arranged at equal intervals along the longitudinal direction. As shown in FIG. 21 and FIG. 25, for one of the first surface 5a and the second surface 5b, the signal contact fingers 53 provided at a same side of the mating region 5 include a plurality of signal finger pairs M to transmit differential signals. Each signal finger pair M is formed by two adjacent signal contact fingers 53, and a first central plane M1, which is a virtual plane perpendicular to the longitudinal direction, exists between the two signal contact fingers 53 of each signal finger pair M. Each of two sides of each signal finger pair M in the longitudinal direction is provided with an adjacent grounding contact finger 54. Among the signal finger pairs M, there is at least one group of two adjacent signal finger pairs M in which only two adjacent grounding contact fingers 54 are provided between the two adjacent signal finger pairs M, and the two extending fingers 55 corresponding to the two adjacent grounding contact fingers 54 are connected in the longitudinal direction. A location connecting the two extending fingers 55 in the longitudinal direction is provided with a first conductive body 56 and a second conductive body 57 shared by both.

As shown in FIG. 21, for one of the first surface 5a and the second surface 5b, the first conductive body 56 and the second conductive body 57 are both located in the mating region 5 limited between the signal contact fingers 53 and the mating edge 51 in the insertion direction, and a ratio of a length of each signal contact finger 53 along the insertion direction to a distance between each signal contact finger 53 and the mating edge 51 is less than or equal to 0.6. Specifically, the length of each signal contact finger 53 along the insertion direction is less than or equal to 1.8 mm, and the distance between each signal contact finger 53 and the mating edge 51 is greater than or equal to 3 mm.

As shown in FIG. 17, FIG. 18 and FIG. 21, for one of the first surface 5a and the second surface 5b, in a signal finger pair M and the two grounding contact fingers 54 located to be adjacent to the signal finger pair M along the longitudinal direction, a central distance C11 between the two signal contact fingers 53 is greater than the central distance C1 between the two first contact portion 31a correspondingly connected to the signal finger pair M, and a central distance C12 between the two grounding contact fingers 54 is greater than the central distance C4 between the two second contact portions 31b correspondingly connected to the two grounding contact fingers 54. In the two adjacent signal finger pairs M and the two grounding contact fingers 54 located between the two adjacent signal finger pairs M, the central distance C8 between two adjacent second contact portions 31b is greater than the central distance C11 between the two grounding contact fingers 54 corresponding to the two adjacent second contact portions 31b.

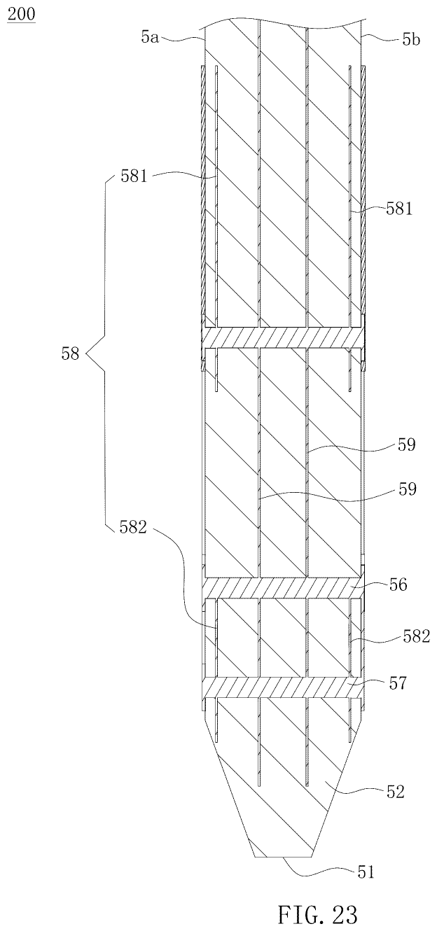

As shown in FIG. 21 and FIG. 23, the mating region 5 is provided with a plurality of grounding layers located between the first surface 5a and the second surface 5b, and the first conductive body 56 and the second conductive body 57 are connected to the grounding layers. The grounding layers include two first grounding layers 58 and two second grounding layers 59, and the two second grounding layers 59 are located between the two first grounding layers 58 in the lateral direction. Each of the two first grounding layers 58 is divided into a first portion 581 and a second portion 582 provided at an interval in the insertion direction. The first portion 581 is provided to be farther away from the mating edge 51 than the second portion 582. A projection of each signal contact finger 53 in the lateral direction at least partially falls in a gap between the first portion 581 and the second portion 582. The second grounding layers 59 protrude toward the mating edge 51 in the insertion direction relative to the first grounding layers 58 and extend into the guiding portions 52.

As shown in FIG. 21 and FIG. 25, the circuit board 300 is provided with a plurality of conductive pad groups N, and each conductive pad group includes a pair of signal conductive pads 61 and two grounding conductive pads 62. The first conductive portion 32a is soldered to a corresponding signal conductive pad 61, and the second conductive portion 32b is soldered to a corresponding grounding conductive pad 62. For the contact fingers and the conductive pad group N electrically connected to the same terminal group R, in the longitudinal direction, a central distance C11 between the two signal contact fingers 53 in contact with the same differential terminal pair 3S is greater than a central distance C13 between the two signal conductive pads 61 in contact with the same differential terminal pair 3S, and a central distance C15 between the grounding contact finger 54 and its adjacent signal contact finger 53 is greater than a central distance C16 between the grounding conductive pad 62 and its adjacent signal conductive pad 61. Viewing from the insertion direction, the first central plane M1 is located between the pair of the signal conductive pads 61 of the same conductive pad group N in the longitudinal direction.

As shown in FIG. 21 and FIG. 25, the pair of signal conductive pads 61 and the two grounding conductive pads 62 in the same conductive pad group N are arranged at equal intervals. A distance between two adjacent conductive pad groups N is greater than a distance between each two adjacent conductive pads of the same conductive pad group N. For two adjacent conductive pad groups N, a central distance C14 between the two adjacent grounding conductive pads 62 is greater than a central distance C12 between two adjacent grounding contact fingers 54 correspondingly conductively connected to the two adjacent grounding conductive pads 62.

As shown in FIG. 1 and FIG. 25, the circuit board 300 is further provided with a plurality of conductive holes 63. The conductive holes 63 include a plurality of first conductive holes 631, a plurality of second conductive holes 632 and a plurality of third conductive holes 633. The second conductive holes 632 are provided to be near the first conductive holes 631 in the longitudinal direction. Viewing from the insertion direction, the first conductive holes 631 are provided opposite to the long slot 121 in the lateral direction. Each of two opposite sides of each conductive pad group N in the longitudinal direction has a virtual boundary line. The first conductive holes 631 are located between two boundary lines of two adjacent conductive pad groups N close to each other in the longitudinal direction. The second conductive holes 632 are provided opposite to the foolproof portion U in the lateral direction. The third conductive holes 633 are provided opposite to the insertion slot 12 in the longitudinal direction. The first guiding legs P41 are accommodated in the first conductive holes 631, the second guiding legs P42 are accommodated in the second conductive holes 632, and the third guiding legs P43 are accommodated in the third conductive holes 633. In other embodiments, the guiding legs P4 may be conductively connected to the circuit board by surface soldering technology.

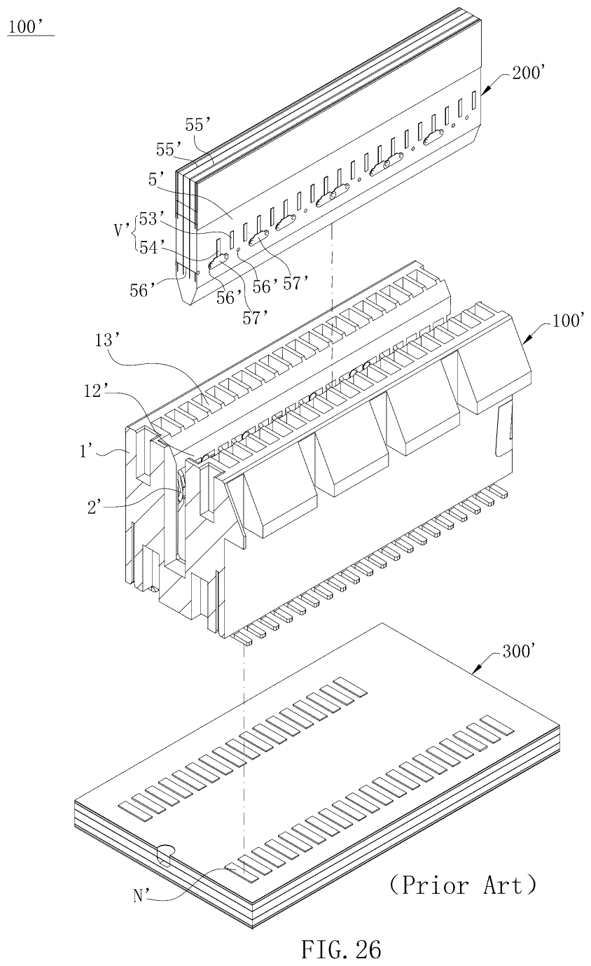

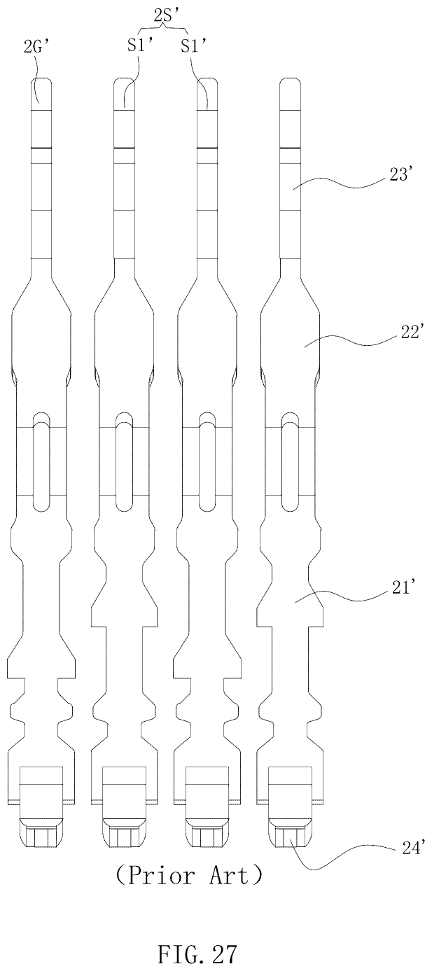

FIG. 26 and FIG. 27 show an existing connector assembly. Using a PCIe 6.0 connector assembly an example, it includes an electrical connector 100′, a mating component 200′ and a circuit board 300′. The electrical connector 100′ is mounted to the circuit board 300′, and the electrical connector 100′ and the mating component 200′ mate with each other. The electrical connector 100′ includes an insulating body 1′, a plurality of conductive terminals 2′ fixed to the insulating body 1′ and a plurality of additional terminals (not shown) fixed to the insulating body 1′. The additional terminals are used to transmit power. The insulating body 1′ has an insertion slot 12′ concavely provided along the insertion direction, and the insertion slot 12′ is used for insertion of the mating component 200′ therein. The mating component 200′ is an electronic card. The insulating body 1′ is further provided with a plurality of terminal slots 13′ located at two sides of the insertion slot 12′ along the lateral direction, and each terminal slot 13′ correspondingly accommodates a conductive terminal 2′. Each conductive terminal 2′ includes a body portion 21′, a connecting arm 22′ connected to one end of the body portion 21′, a contact portion 23′ connected to the connecting arm 22′ and a conductive portion 24′ located at another end of the body portion 21′. The contact portion 23′ is exposed to the insertion slot 12′ to mate with the mating component 200′. The conductive portion 21′ protrudes out of the insulating body 1′ to be conductively connected to the circuit board 300′. Each of the two opposite sides of the insertion slot 12′ is distributed with a plurality of conductive terminals 2′, and includes a plurality of differential terminal pairs 2S′ and a plurality of ground terminals 2G′. Each differential terminal pair 2S′ includes two signal terminals S1′. Each of two sides of each differential terminal pair 2S′ along the longitudinal direction is adjacent to one ground terminal 2G′. Each of the signal terminals S1′ is provided to be symmetrical along its central line, and each of the ground terminals 2G′ is provided to be symmetrical along its central line. The signal terminals S1′ and the ground terminals 2G′ at each of the two opposite sides of the insertion slot 12′ are distributed at equal intervals along the longitudinal direction. In the same differential terminal pair 2S′, a central distance between the two contact portions 23′ is equal to a central distance between the two connecting arms 22′, and the central distance between the two contact portions 23′ is equal to a central distance between the two conductive portions 24′.

As shown in FIG. 26 and FIG. 27, the mating component 200′ includes two mating surfaces 5′ provided opposite to each other along the lateral direction. The mating component 200′ is provided with a plurality of contact fingers V′ arranged at equal intervals along the longitudinal direction and exposed to the mating surfaces 5′. The contact fingers V′ are used to be electrically connected to the contact portions 23′. The contact fingers V′ include a plurality of signal contact fingers 53′ and a plurality of grounding contact fingers 54′. Bottom edges of the signal contact fingers 53′ and the grounding contact fingers 54′ along the insertion direction are located on a same plane. A plurality of grounding layers 55′ are provided between the two mating surfaces 5′. There are two grounding layers 55′. The mating component 200′ is provided with a row of conductive structures 56′ located below the contact fingers V′ and separated from the contact fingers V′. An extending finger 57′ extends from each grounding contact finger 54′, and a portion of each conductive structure 56′ exposed on the mating surface 5′ is connected to the corresponding grounding contact finger 54′ through the extending finger 57′. The conductive structures 56′ run through the two grounding layers 55′ along the lateral direction. A ratio of a length of each signal contact finger 53′ along the insertion direction to a distance between each signal contact finger 53′ and the bottom edge of the mating component 200′ is close to 1. Specifically, the length of each signal contact finger 53′ along the insertion direction is 2.5 mm, and the distance between each signal contact finger 53′ and the bottom edge of the mating component 200′ is 2.6 mm.

As shown in FIG. 26, the circuit board 300′ includes a plurality of conductive pads N′, and the conductive pads N′ are used to be conductively connected to the conductive portions 24′. A distance between two adjacent contact fingers V′ is equal to a distance between two adjacent conductive pads N′. For the conductive terminals 2′ at the same side of the insertion slot 12′, a gap between any two adjacent contact fingers V′ mated thereto is equal to a gap between any two adjacent conductive pads N′ mated thereto.

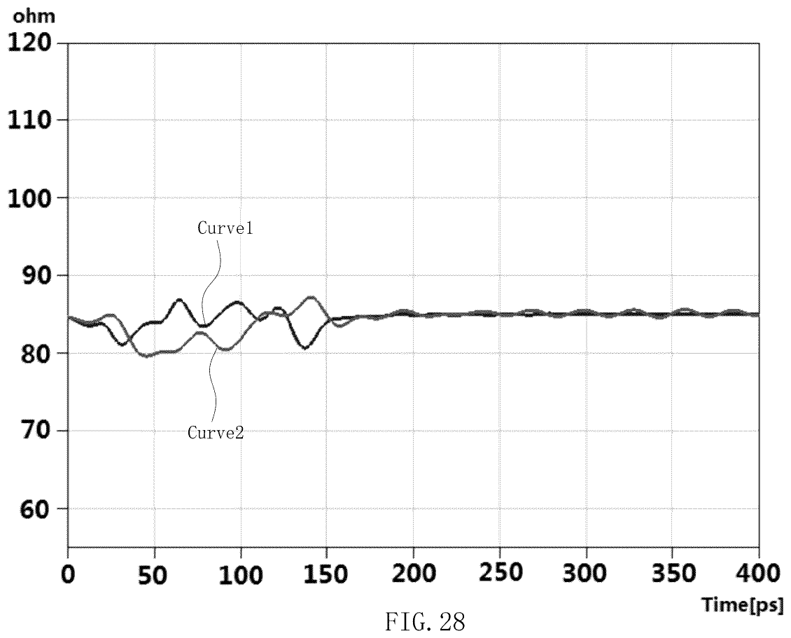

FIG. 28 shows the high frequency impedance analysis of the connector assembly in the prior art and the connector assembly according to the present invention, in which a curve 1 shows the impedance analysis of the connector assembly according to the present invention, and a curve 2 shows the impedance analysis of the connector assembly in the prior art. The impedance value for both of the curve 1 and the curve 2 at 0 ps are controlled at 85. As the test time increases, the impedance value of the connector assembly according to the present invention (the curve 1) is consistently controlled within the range of (80, 90), while the impedance value of the connector assembly in the prior art (the curve 2) has a larger range. At 150 ps, the impedance value of the connector assembly according to the present invention tends to stabilize, while the impedance value of the connector assembly in the prior art continues to fluctuate slightly. Thus, it is shown that the impedance value of the connector assembly according to the present invention is better matched, achieving better high frequency performances.

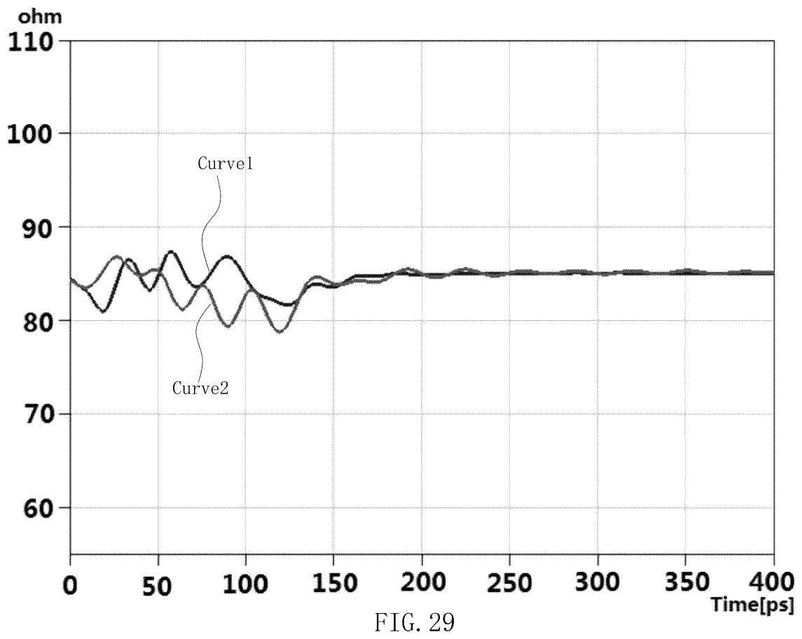

FIG. 29 shows the high frequency impedance analysis of the prior art and the connector assembly according to the present invention from the electronic card to the circuit board, in which a curve 1 shows the impedance line of the connector assembly according to the present invention, and a curve 2 shows the impedance line of the connector assembly in the prior art. The impedance value for both of the curve 1 and the curve 2 at 0 ps are controlled at 85. As the test time increases, the impedance value of the connector assembly according to the present invention (the curve 1) is consistently controlled within the range of (80, 90), while the impedance value of the connector assembly in the prior art (the curve 2) has a larger range. At 150 ps, the impedance value of the connector assembly according to the present invention tends to stabilize, while the impedance value of the connector assembly in the prior art continues to fluctuate slightly. Thus, it is shown that the impedance value of the connector assembly according to the present invention is better matched, achieving better high frequency performances.

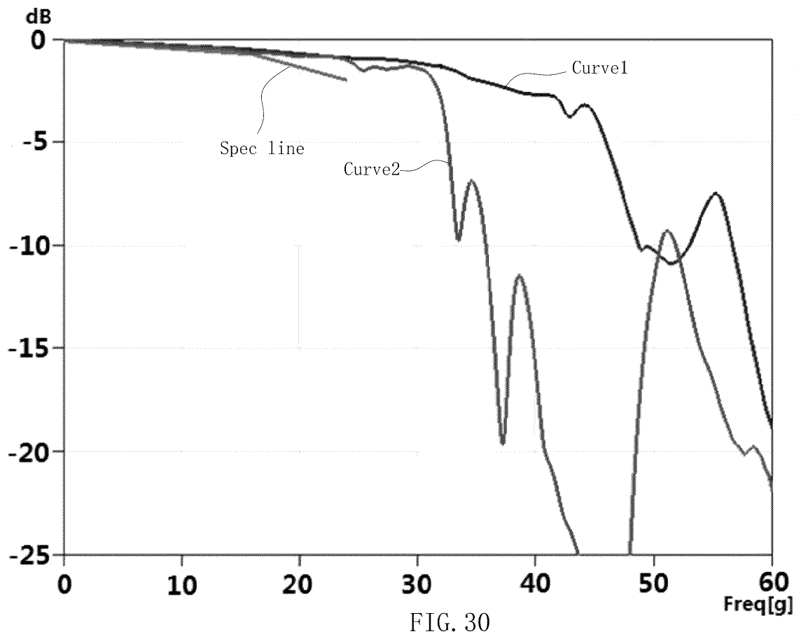

FIG. 30 shows the insertion loss analysis of the prior art and the connector assembly according to the present invention, in which a curve 1 shows the insertion loss line of the connector assembly according to the present invention, and a curve 2 shows the insertion loss line of the connector assembly in the prior art. Compared to the spec line, before the signal transmission frequency reaches 30 GHz, both of the curve 1 and the curve 2 may satisfy the transmission requirements. However, after the frequency exceeds 30 GHz, the insertion loss (IL) of the curve 2 rapidly reduces, thus affecting the signal transmission of the electrical connector. In comparison, in the connector assembly according to the present invention, a significant drop of the IL occurs after reaching 45 GHz, and the IL drop issue is significantly reduced in the higher frequency signal transmission process.

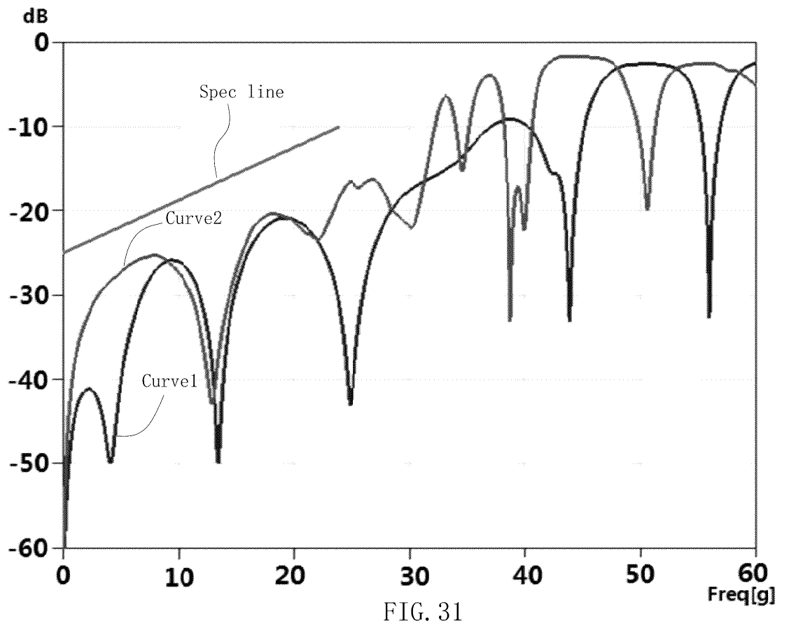

FIG. 31 shows the return loss analysis of the prior art and the connector assembly according to the present invention, in which a curve 1 shows the return loss line of the connector assembly according to the present invention, and a curve 2 shows the return loss line of the connector assembly in the prior art. Compared to the spec line, both of the curve 1 and the curve 2 are below the spec line and satisfy the transmission requirements. Further, the return loss of the connector assembly according to the present invention is mostly lower than the return loss of the connector assembly in the prior art, which is desirable for high frequency signal transmission of the electrical connector.

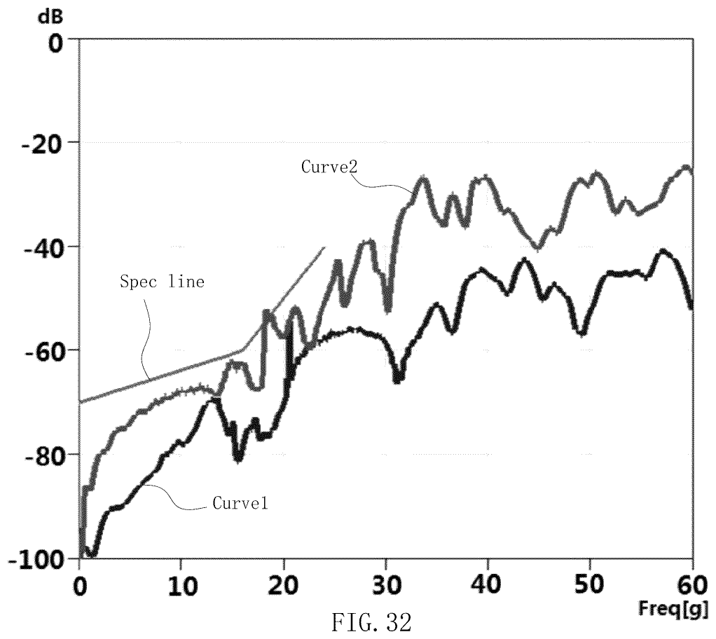

FIG. 32 shows the near-end crosstalk analysis of the prior art and the connector assembly according to the present invention, in which a curve 1 shows the near-end crosstalk line of the connector assembly according to the present invention, and a curve 2 shows the near-end crosstalk line of the connector assembly in the prior art. The curve 1, with the increase of the frequency, is steadily below the spec line, and the curve 2 slightly exceeds the spec line at 20 GHz, which is not conducive to the signal transmission. Further, the near-end crosstalk of the curve 1 is lower, and the near-end crosstalk of the connector assembly according to the present invention is significantly reduced compared to the near-end crosstalk in the prior art.

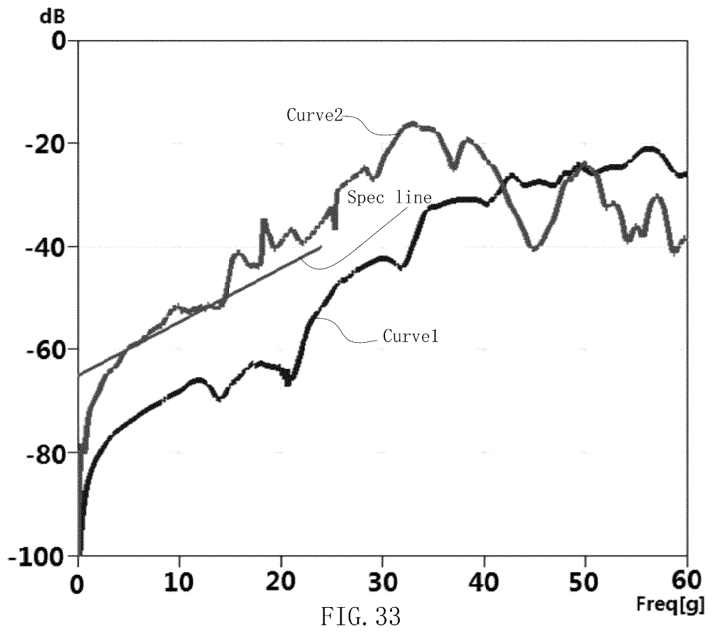

FIG. 33 shows the far-end crosstalk analysis of the prior art and the connector assembly according to the present invention, in which a curve 1 shows the far-end crosstalk line of the connector assembly according to the present invention, and a curve 2 shows the far-end crosstalk line of the connector assembly in the prior art. The curve 1, with the increase of the frequency, is steadily below the spec line, and the far-end crosstalk of the connector assembly according to the present invention is significantly reduced compared to the far-end crosstalk in the prior art.

The electrical connector and the connector assembly according to certain embodiments of the present invention have the following beneficial effects:

1. In the differential terminal pair 3S, a central distance between the two first contact portions 31a of the two signal terminals is greater than a central distance between the two first connecting arms 332a of the two signal terminals, and the central distance between the two first contact portions 31a of the two signal terminals is greater than a central distance between the two first conductive arms 32a of the two signal terminals, such that the differential terminal pair 3S forms a good differential coupling, and the distance between adjacent differential terminal pairs 3S is increased, thereby reducing the far-end crosstalk between the differential terminal pairs 3S.

2. In the differential terminal pair 3S, a central distance C2 between the two first contact portions 332a is greater than a central distance C3 between the two first conductive arms 32a, such that the distance between adjacent differential terminal pairs 3S is further increased, thereby reducing the far-end crosstalk between the differential terminal pairs 3S.

3. For the two ground terminals 3G at two sides of the differential terminal pair 3S, a central distance C4 between the two second contact portions 31b is greater than a central distance C5 between the two second connecting arms 332b, and the central distance C4 between the two second contact portions 31b is greater than a central distance C6 between the two second conductive portion 32b, such that the second connecting arms 332b and the second conductive portions 32b bend toward directions close to the differential terminal pair 3S. The two first connecting arms 332a of the differential terminal pair 3S are at the high impedance points, and the second connecting arms 332b are close to the first connecting arms 332a to reduce the impedances of the two first connecting arms 332a of the differential terminal pair 3S, such that the overall impedance of the differential terminal pair 3S matches, thereby improving the high frequency performances. The second conductive portions 32b are close to the first conductive portions 32a of the differential terminal pair 3S, thereby shortening the return path of the signal terminals S1, and enhancing the transmission velocity of the differential terminal pair 3S.

4. The mating component 200 is provided with the extending fingers 55 connected to the grounding contact fingers 54 on the first surface 5a and the second surface 5b, and a width of each extending finger 55 in the longitudinal direction is wider than a width of each grounding contact finger 54. Each extending finger 55 is provided with the first conductive body 56 and the second conductive body 57 at an interval in the insertion direction, such that the mating component 200 increases the return path, reducing the near-end crosstalk of the electrical connector 100.

5. The mating component 200 is provided with the second grounding layers 59 extending into the guiding portions 52 between the first surface 5a and the second surface 5b, thus shielding the radiation interferences between the conductive terminals 3 in the two rows respectively conductive connected to the first surface 5a and the second surface 5b, and reducing the near-end crosstalk of the electrical connector 100.

6. Each of the two first grounding layers 58 is divided into a first portion 581 and a second portion 582 provided at an interval in the insertion direction. The first portion 581 is provided to be farther away from the mating edge 51 than the second portion 582. A projection of each signal contact finger 53 in the lateral direction at least partially falls in a gap between the first portion 581 and the second portion 582. Each signal contact finger 53 is in contact with the corresponding first contact portion 31a, such that the thickness of the contacting portions increases, resulting in an increased capacitance of the contacting portions. The first portion 581 and the second portion 582 are separated in the projection region of the corresponding signal contact finger 53 in the lateral direction, such that the capacitance of the corresponding signal contact finger 53 is reduced, thereby matching the impedance and improving the high frequency performances.

7. A ratio of a length of each signal contact finger 53 along the insertion direction to a distance between each signal contact finger 53 and the mating edge 51 is less than or equal to 0.6, such that the length of each signal contact finger 53 is reduced, thereby shortening the distance between the bottom end of the signal contact finger 53 close to the mounting surface 12 along the insertion direction and the contact point with the first contact portion 31a when the first contact portion 31a is in contact with the signal contact finger 53, and reducing the insertion loss of the signal terminal.

8. The mating component 200 is an electronic card, and the first surface 5a and the second surface 5b are provided with a plurality of contact fingers arranged at equal intervals along the longitudinal direction. The circuit board 300 is provided with a plurality of conductive pad groups N, and the pair of signal conductive pads 61 and the two grounding conductive pads 62 in the same conductive pad group N are arranged at equal intervals. A central distance C11 between two adjacent contact fingers is greater than a central distance C13 between the two adjacent signal conductive pads 61 of the same conductive pad group N, thus ensuring compatibility with the gap between the contact fingers of the electronic card 200 in the previous version, and reducing the gap between the signal conductive pads 61 of the same conductive pad group N, thereby increasing the distance between two adjacent conductive pad groups N. The conductive terminals 3 on the electrical connector 100 connected to the contact fingers and the conductive pad groups N are also adjusted accordingly, thus reducing the crosstalk interference of the electrical connector 100.

9. After the mating component 200 is inserted into the insertion slot 12, the first contact portion 31a forms a low impedance point. The main body 1 is provided with a plurality of grooves 0 corresponding to the differential terminal pairs 3S, thus reducing the plastic material around the first contact portion 31a, thereby increasing the air around the first contact portion 31a and reducing the capacitance of the first contact portion 31a, such that the overall impedance of the differential terminal pairs 3S matches, resulting in better high frequency performances.

10. The shielding shell P is provided with a plurality of first guiding legs P41, thus increasing the connecting strength between the electrical connector 100 and the circuit board 300. After the mating component 200 is inserted into the main body 1, the shielding shell P supports the mating component 200, preventing the gravitational force of the mating component 200 from being excessively applied to the electrical connector 100 and causing deformation of the electrical connector 100. In addition, the first guiding legs P41 are located between the boundary lines M1 of two adjacent conductive pad groups N, reducing the crosstalk between the adjacent conductive pad groups N, and the relatively large space between the two adjacent conductive pad groups N may be utilized for the rational arrangement of the first guiding legs P41.

11. The second body portion 331b of each ground terminal 3G is electrically connected to the conductive plastic 4. The second body portion 331b of each ground terminal 3G is provided with a retracted notch 331b2 recessed inward relative to the plane on which the second connecting edge 332b2 is located along the longitudinal direction, and the retraction distance W5 of the retracted notch 331b2 relative to the plane on which the second connecting edge 332b2 is located is greater than or equal to 0.2 mm, such that the ground terminals 3G are away from the differential terminal pairs 3S, reducing the electric charge crosstalk interference on the conductive plastic 4.

12. The first body portion 331a is insert-molded in the insulating block 21, resulting in a relatively low impedance of the first body portion 331a. The first body portion 331a is provided with a first retracted portion 3311 relative to the first connecting side edge 332b1 and a second retracted portion 3312 relative to the second connecting side edge in the longitudinal direction, thus increasing the impedance of the first body portion 331a, such that the impedance of the differential terminal pair 3S matches, improving high frequency performances.

13. Two ground terminals 3G are provided to be adjacent to each other between two adjacent differential terminal pairs 3S, and the distance between the two second contact portions 31b of the two ground terminals 3G is less than the distance between the two conductive portions 32b. The distance between the two conductive portions 32b is longer, such that the second conductive portions 32b are closer to the differential terminal pairs 3S, thus shortening the return path of the signal terminals S1, and enhancing the transmission velocity of the differential terminal pairs 3S.

14. The circuit board 300 includes a plurality of conductive pad groups N, and the distance between two adjacent conductive pad groups N is greater than the distance between each two adjacent conductive pads of the same conductive pad group N, thus increasing the distance between the signal conductive pads 61 of the two adjacent conductive pad groups N, and reducing the far-end crosstalk between the signal conductive pads 61 of the two adjacent conductive pad groups N.

15. A central distance between two adjacent signal contact fingers 53 provided on the mating component 200 is a standard distance C11, and a central distance C11 between the two signal contact fingers 53 in contact with the same differential terminal pair 3S is greater than a central distance C1 between the two first contact portion 31a of the corresponding differential terminal pair 3S, such that the two adjacent differential terminal pairs 3S are away from each other, thereby reducing the parasitic capacitance coupling between the different ones of the differential terminal pairs 3S, and further reducing the mutual interference between the different ones of the differential terminal pairs 3S.

16. A width of each separation wall 15 in the longitudinal direction is greater than a width of each column 14, thus increasing the structural strength of the main body 1. Each insulating block 21 is concavely provided with the notch portions 214 at a side facing toward the mating surface 10 in the insertion direction, and the corresponding separation wall 15 is engaged into the notch portions 214, such that each insulating block 21 and the corresponding separation wall 15 match with each other, thereby stably assembling each insulating block 21 to the main body.

17. By providing the signal slots 16 between the two adjacent columns 14 at the same side of the insertion slot 12 and providing the insulating protrusions 222 on the terminal seat 2, the insulating protrusions 222 are accommodated in the signal slots 16, and the insulating protrusions 222 are provided between the insertion slot 12 and the differential terminal pairs 3S in the lateral direction. Viewing along the lateral direction, the two first connecting arms 332a of the differential terminal pair 3S both partially overlap with one of the corresponding insulating protrusions 222, thus reducing the air around the two first connecting arms 332a of the differential terminal pair 3S, and the insulating protrusions 222 shield one side of the first connecting arms 332a facing the insertion slot 12 in the lateral direction, increasing the dielectric constant around the two first connecting arms 332a of the differential terminal pair 3S, thus increasing the capacitance of the two first connecting arms 332a of the differential terminal pair 3S, reducing the characteristic impedance and making the impedance of the differential terminal pair 3S more matched, thereby improving the high frequency performances.

18. By providing a separation rib 18 between the two first connecting arms 332a of the differential terminal pair 3S, the air around the two first connecting arms 332a is reduced, and the plastic content between the two first connecting arms 332a of the differential terminal pair 3S is increased, thereby increasing the dielectric constant around the two first connecting arms 332a of the differential terminal pair 3S, increasing the capacitance, and reducing the impedance, such that the impedance of the differential terminal pair 3S matches, thereby improving the high frequency performances. Since the gap between the differential terminal pairs 3S is small, the dimension of each separation rib 18 in the longitudinal direction is provided to be smaller than the dimension of each column 14 in the longitudinal direction, thus avoiding interference with the differential terminal pair 3S and affecting the performance of the electrical connector 100. Each separation rib 18 is located away from the insertion slot 12 relative to the columns 14 in the lateral direction, and the size of each separation rib 18 in the lateral direction is smaller than the dimension of each column 14 in the lateral direction, thus facilitating the forming of the separation ribs 18 in the process.

19. The first side surface 183 and the second side surface 184 extend obliquely toward the side adjacent to the insertion slot 12 in the lateral direction. That is, the first side surface 183 and the second side surface 184 are guiding slopes that extend obliquely. Each separation rib 18 becomes wider as it gets closer to the outer side of the main body 1 in the lateral direction, such that when the first connecting arms 332a of the differential terminal pair 3S are subjected to an external force from the mating component 200 and move toward a direction away from the insertion slot 12 in the lateral direction, the first connecting arms 332a may be guided so as to prevent the first connecting arms 332a of the differential terminal pair 3S from getting stuck.

20. The insulating protrusions 222 are provided to be closer to the mating surface 10 relative to the second far end 181, and the insulating protrusions 222 shield the second far end 181 in the lateral direction, such that along the longitudinal direction, the portions of the two first connecting arms 332a of each differential terminal pair 3S not being shielded by the separation rib 18 may be shielded by the insulating protrusions 222 in the lateral direction, thereby ensuring that at least a portion of the various portions of the two first connecting arms 332a of each differential terminal pair 3S in their extending directions may be covered by plastic in different angles, and adjusting the overall impedance of the two first connecting arms 332a of each differential terminal pair 3S.

21. A distance between the two first sections 3321 of each differential terminal pair 3S in the longitudinal direction is less than a distance between the two second sections 3322 of each differential terminal pair 3S in the longitudinal direction, and each separation rib 18 is located between the two first sections 3321 of each differential terminal pair 3S in the longitudinal direction. The first contact portions 31a of the differential terminal pair 3S are subjected to the external force of the mating component 200 and move, thus effectively limiting the positions of the two first connecting arms 332a of the differential terminal pair 3S, preventing the two first sections 3321 of each differential terminal pair 3S from short-circuiting due to being too close and in contact with each other.

22. Each insulating protrusion 222 is provided with a stopping block 2221 protruding from a side away from the insertion slot 12 along the lateral direction, and the stopping block 2221 is clamped to a side of one of the two insulating blocks 21 facing toward the mating surface 10 in the insertion direction, thereby preventing the insulating member 22 from detaching from the main body 1 toward the mounting surface 11.

23. Each insulating protrusion 222 is provided with a matching surface 2222 at a side facing toward the first connecting arms 332a, and a portion of the matching surface 2222 extends on the corresponding stopping block 2221, such that a distance between each first connecting arm 332a and the matching surface 2222 in the lateral direction is relatively uniform from an overall perspective, thus facilitating the adjustment of the characteristic impedance.

24. By providing a plurality of extending portions 42 on the conductive plastic 4 to be closer to the mating surface 10 than the base body 41 in the insertion direction, the extending portions 42 protrude into the corresponding inner slot 213 in the lateral direction and are provided correspondingly with the ground terminals 3G, allowing the conductive plastic 4 to be electrically connected to the ground terminals 3G, such that the conductive plastic 4 may be limited between the two corresponding insulating blocks 21 in the lateral direction and the longitudinal direction, the conductive plastic 4 is correctly aligned with the grounding terminals 3G, and the corresponding arrangement of the two may shorten the return path of grounding, thus reducing resonance thereof.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
a main body;
a plurality of differential terminal pairs provided in the main body; and
at least one ground terminal provided in the main body, wherein the at least one ground terminal is provided between two adjacent ones of the differential terminal pairs along a longitudinal direction;
wherein each of the differential terminal pairs comprises two signal terminals, each of the signal terminals comprises a first body portion, a first contact portion, a first conductive portion and a first connecting arm connected to one end of the first body portion and the first contact portion, the first body portion is located between the first connecting arm and the first conductive portion, the ground terminal comprises a second body portion, a second contact portion, a second conductive portion and a second connecting arm connected to one end of the second body portion and the second contact portion, and the second body portion is located between the second connecting arm and the second conductive portion,
wherein for one of the differential terminal pairs, in the longitudinal direction, a central distance between the two first contact portions of the two signal terminals is greater than a central distance between the two first connecting arms of the two signal terminals, and the central distance between the two first contact portions of the two signal terminals is greater than a central distance between the two first conductive arms of the two signal terminals.

2. The electrical connector according to claim 1, wherein for the one of the differential terminal pairs, a side of each of the two first contact portions of the two signal terminals away from each other in the longitudinal direction comprises a first contact side edge, a side of each of the two first connecting arms of the two signal terminals away from each other in the longitudinal direction comprises a first connecting side edge, another side of each of the two first connecting arms of the two signal terminals adjacent to each other in the longitudinal direction comprises a second connecting side edge, the first contact side edge and the first connecting side edge of one of the two signal terminals are located on a same plane perpendicular to the longitudinal direction, the first body portion comprises a first retracted portion retracted relative to the first connecting side edge and a second retracted portion retracted relative to the second connecting side edge in the longitudinal direction, and a retraction distance of the first retracted portion is greater than a retraction distance of the second retracted portion.

3. The electrical connector according to claim 1, comprising a plurality of ground terminals, wherein two opposite sides of each of the differential terminal pairs are respectively provided with two ground terminals of the ground terminals, each of the differential terminal pairs and the two ground terminals at the two sides thereof are defined as a terminal group, for the two ground terminals in the terminal group, in the longitudinal direction, a central distance between the two second contact portions of the two ground terminals is greater than a central distance between the two second connecting arms of the two ground terminals, and the central distance between the two second contact portions of the two ground terminals is greater than a central distance between the two second conductive arms of the two ground terminals.

4. The electrical connector according to claim 3, wherein for the terminal group, in the longitudinal direction, the central distance between the two first connecting arms of the two signal terminals is greater than the central distance between the two first conductive arms of the two signal terminals, and the central distance between the two second connecting arms of the two ground terminals is greater than the central distance between the two second conductive arms of the two ground terminals.

5. The electrical connector according to claim 3, wherein for the terminal group, a side of each of the two second contact portions of the two ground terminals away from the differential terminal pair in the longitudinal direction comprises a first contact edge, a side of each of the two second connecting portions of the two ground terminals away from the differential terminal pair in the longitudinal direction comprises a first connecting edge, a side of each of the two second body portions of the two ground terminals away from the differential terminal pair in the longitudinal direction comprises a first body edge, the first contact edge, the first connecting edge and the first body edge are located on a same plane, a side of each of the two second connecting arms of the two ground terminals adjacent to the differential terminal pair in the longitudinal direction comprises a second connecting edge, and the second body portion of each of the two ground terminals is provided with a retracted notch recessed inward relative to the second connecting edge such that the second body portion is away from the differential terminal pair.

6. The electrical connector according to claim 5, wherein the terminal group is fixed in an insulating block, the insulating block is provided with an inner slot corresponding to the second body portion, the inner slot runs through a surface away from the second body portion in a lateral direction, and the retracted notch is at least partially exposed in the inner slot.

7. The electrical connector according to claim 5, further comprising a conductive plastic, wherein a portion of the second body portion located at a side of the retracted notch in the longitudinal direction is defined as a narrow portion, the conductive plastic is provided with a plurality of extending portions, the extending portions are one-to-one correspondingly in contact or adjacent to and electrically connected to the narrow portions of the ground terminals, and in the terminal group, a central distance between the two narrow portions of the two second body portions of the two ground terminals is greater than the central distance between two corresponding ones of the extending portions.

8. The electrical connector according to claim 1, comprising a plurality of ground terminals, wherein two ground terminals of the ground terminals adjacent to each other are provided between two adjacent ones of the differential terminal pairs, in the longitudinal direction, a distance between the two second conductive portions of the two ground terminals adjacent to each other is greater than a distance between the two second contact portions of the two ground terminals, and a central distance between the two second conductive portions of the two ground terminals is greater than a central distance between the two second contact portion of the two ground terminals.

9. An electrical connector, comprising:
a main body, provided with a mating surface and an insertion slot, wherein the insertion slot is concavely formed in an insertion direction from the mating surface, two side walls are respectively provided at two opposite sides of the insertion slot along a lateral direction, the side walls are provided with a plurality of columns along a longitudinal direction, a signal slot is formed between two adjacent ones of the columns of a same one of the side walls, and any two of the longitudinal direction, the lateral direction and the insertion direction are perpendicular to each other;
a plurality of terminal groups, provided in the main body, wherein each of the terminal groups comprises a differential terminal pair and two ground terminals located at two opposite sides of the differential terminal pair, the differential terminal pair comprises two signal terminals, each of the signal terminals comprises a first body portion, a first contact portion, a first conductive portion and a first connecting arm connected to one end of the first body portion and the first contact portion, the first body portion is located between the first connecting arm and the first conductive portion, each of the ground terminals comprises a second body portion, a second contact portion, a second conductive portion and a second connecting arm connected to one end of the second body portion and the second contact portion, the second body portion is located between the second connecting arm and the second conductive portion, the first contact portion and the second contact portion are exposed in the insertion slot, and the differential terminal pair is accommodated in the signal slot; and
an insulating member, having a plurality of insulating protrusions, the insulating protrusions are located between the insertion slot and the two first connecting arms of the two signal terminals of the corresponding differential terminal pair in the lateral direction.

10. The electrical connector according to claim 9, wherein at least one of the side walls comprises a plurality of separation ribs, each of the separation ribs is located between the two first connecting arms of the two signal terminals of the differential terminal pair, a width of the separation ribs in the longitudinal direction is less than a width of each of the columns in the longitudinal direction, each of the separation ribs comprises a first far end away from the mating surface in the insertion direction, each of the columns comprises a second far end away from the mating surface in the insertion direction, and the first far end is provided to be closer to the mating surface than the second far end.

11. The electrical connector according to claim 10, wherein each of the separation ribs comprises a first side surface and a second side surface provided opposite to each other in the longitudinal direction, and the first side surface and the second side surface extend obliquely toward a side adjacent to the insertion slot in the lateral direction.

12. The electrical connector according to claim 10, wherein each of the signal terminals comprises a first tail portion connected to the first contact portion, the first tail portion and the first connecting arm are connected to two ends of the first contact portion in the insertion direction, at least one of the side walls comprises a plurality of protruding ribs, each of the protruding ribs is located between the two first tail portions of the two signal terminals of the differential terminal pair, each of the protruding ribs is provided to be closer to the mating surface than a corresponding one of the separation ribs, each of the protruding ribs and the corresponding one of the separation ribs are provided at an interval in the insertion direction, and the width of each of the separation ribs in the longitudinal direction and the width of each of the columns in the longitudinal direction are both less than a width of each of the protruding ribs in the longitudinal direction.

13. The electrical connector according to claim 9, wherein each of the signal terminals comprises a first tail portion connected to the first contact portion, at least one of the side walls comprises a plurality of protruding ribs and a plurality of grooves, each of the protruding ribs is located between the two first tail portions of the two signal terminals of the differential terminal pair, each of the grooves is located at a position corresponding to the differential terminal pair, each of the grooves is provided to correspond to a corresponding one of the protruding ribs between the differential terminal pair in the lateral direction, and each of the grooves runs through the mating surface in the insertion direction.

14. A connector assembly, comprising:
an electrical connector, comprising a main body, wherein the main body is provided with a mating surface and an insertion slot, the insertion slot is concavely formed in an insertion direction from the mating surface, two side walls are respectively provided at two opposite sides of the insertion slot along a lateral direction, each of the side walls is provided with a plurality of differential terminal pairs and a plurality of ground terminals arranged along a longitudinal direction, and any two of the longitudinal direction, the lateral direction and the insertion direction are perpendicular to each other, wherein each of the differential terminal pairs and two of the ground terminals at two sides thereof form a terminal group, each of the differential terminal pairs comprises two signal terminals, each of the signal terminals comprises a first body portion, a first contact portion, a first connecting arm connected to one end of the first body portion and the first contact portion and a first conductive portion extending from the other end of the first body portion, each of the ground terminals comprises a second body portion, a second contact portion, a second connecting arm connected to one end of the second body portion and the second contact portion and a second conductive portion extending from the other end of the second body portion, and the first contact portion and the second contact portion are exposed in the insertion slot;
a mating component, comprising a mating region inserted in the insertion slot, wherein the mating region comprises a first surface and a second surface provided to be opposite to each other in the lateral direction, the first surface and the second surface are both provided with contact fingers arranged at equal intervals along the longitudinal direction, the contact fingers comprise a plurality of signal contact fingers and a plurality of grounding contact fingers, the first contact portion is in contact with a corresponding one of the signal contact fingers, and the second contact portion is in contact with a corresponding one of the grounding contact fingers; and
a circuit board, wherein the electrical connector is mounted on the circuit board, the circuit board is provided with a plurality of conductive pads arranged in rows, the conductive pads in each row comprise a plurality of conductive pad groups, each of the conductive pad groups comprises a pair of signal conductive pads and two grounding conductive pads, the first conductive portion is soldered to a corresponding one of the signal conductive pads, the second conductive portion is soldered to a corresponding one of the grounding conductive pads, and in the longitudinal direction, a central distance between two of the signal contact fingers in contact with a same one of the differential terminal pairs is greater than a central distance between two of the signal conductive pads in contact with the same one of the differential terminal pairs.

15. The connector assembly according to claim 14, wherein the mating region comprises a mating edge and at least one grounding layer located between the first surface and the second surface, the mating edge and the signal contact fingers are provided at intervals in the insertion direction, one side of each of the grounding contact fingers close to the mating edge along the insertion direction is connected to an extending finger, each of the extending finger is provided on one of the first surface and the second surface, a width of the extending finger in the longitudinal direction is wider than a width of each of the grounding contact fingers, the mating region is further provided with a first conductive body and a second conductive body corresponding connected to the extending finger and the grounding layer and at an interval in the insertion direction.

16. The connector assembly according to claim 15, wherein the signal contact fingers provided on the first surface or the second surface of the mating region comprise a plurality of signal finger pairs, each of the signal finger pairs is formed by two adjacent ones of the signal contact fingers, each of two sides of each of the signal finger pairs in the longitudinal direction is provided with an adjacent one of the grounding contact fingers, only two adjacent ones of the grounding contact fingers are provided between two adjacent ones of the signal finger pairs, and two of the extending fingers corresponding to the two adjacent ones of the grounding contact fingers are connected in the longitudinal direction.

17. The connector assembly according to claim 15, wherein the mating region comprises a guiding portion located between the extending finger and the mating edge in the insertion direction, a thickness of the guiding portion in the lateral direction gradually becomes smaller along a direction from the extending finger toward the mating edge, the mating region comprises a plurality of grounding layers, the grounding layers comprise two first grounding layers and two second grounding layers, the two second grounding layers are located between the two first grounding layers in the lateral direction, the second grounding layers protrude toward the mating edge in the insertion direction relative to the first grounding layers and extend into the guiding portion.

18. The connector assembly according to claim 17, wherein each of the two first grounding layers is divided into a first portion and a second portion provided at an interval in the insertion direction, the first portion is provided to be farther away from the mating edge than the second portion, and a projection of each of the signal contact fingers in the lateral direction at least partially falls in a gap between the first portion and the second portion.

19. The connector assembly according to claim 15, wherein a ratio of a length of each of the signal contact fingers along the insertion direction to a distance between each of the signal contact fingers and the mating edge is less than or equal to 0.6.

20. The connector assembly according to claim 14, wherein the main body is provided with a foolproof portion in the insertion slot, the foolproof portion divides the insertion slot into a long slot and a short slot, the electrical connector comprises a shielding shell covering outside the main body, the shielding shell is provided with a plurality of guiding legs, the guiding legs comprise a plurality of first guiding legs, viewing along the insertion direction, the first guiding legs are provided to be opposite to the long slot in the lateral direction; the circuit board is provided with a plurality of conductive holes, the conductive holes comprise a plurality of first conductive holes, each of two opposite sides of each of the conductive pad groups in the longitudinal direction comprises a virtual boundary line, the first conductive holes are located between the virtual boundary lines of two adjacent ones of the conductive pad groups in the longitudinal direction, and the first guiding legs are accommodated in the first conductive holes.

21. The connector assembly according to claim 14, wherein the main body is provided with a foolproof portion in the insertion slot, the foolproof portion divides the insertion slot into a long slot and a short slot, viewing from the insertion direction, the conductive pad groups are provided to be opposite to the long slot in the lateral direction, the pair of signal conductive pads and the two grounding conductive pads in a same one of the conductive pad groups are arranged at equal intervals, in the longitudinal direction, a central distance between two adjacent ones of the conductive pad groups is greater than a central distance between two adjacent conductive pads of the same one of the conductive pad groups, and for the contact fingers and the conductive pad groups electrically connected to the terminal group, a virtual plane passing a center of two adjacent ones of the signal contact fingers arranged along the longitudinal direction is defined as a first central plane, and the first central plane is located between the pair of the signal conductive pads in the longitudinal direction.
